(19) United States
(12) Patent Application Publication
(10) Pub. No.: US 2024/0316496 A1
(43) Pub. Date: Sep. 26, 2024

(54) NOX ADSORBER DIESEL OXIDATION CATALYST

(71) Applicant: BASF CORPORATION, Florham Park, NJ (US)

(72) Inventors: Gerd GRUBERT, Hannover (DE); Arne Tobias NIGGEBAUM, Hannover (DE); Emre EMMEZ, Ludwigshafen am Rhein (DE); Torsten NEUBAUER, Hannover (DE); Xinyi WEI, Iselin, NJ (US); Jeffrey B HOKE, Iselin, NJ (US)

(21) Appl. No.: 18/573,243

(22) PCT Filed: Jun. 29, 2022
(86) PCT No.: PCT/EP2022/067857

§ 371 Date: Dec. 21, 2023

(30) Foreign Application Priority Data
Jun. 30, 2021 (EP) 21182719.1

(51) Int. Cl. B01D 53/94; B01J 23/42; B01J 29/74; B01J 35/00; B01J 35/56; B01J 37/02

(52) U.S. Cl. CPC B01D 53/945; B01D 53/9468; B01J 23/42; B01J 29/7484; B01J 35/19; B01J 35/56; B01J 37/0246; B01D 2255/1021; B01D 2255/1023; B01D 2255/204; B01D 2255/2073; B01D 2255/50; B01D 2255/9022; B01D 2255/9155; B01D 2257/404; B01D 2257/502; B01D 2257/702; B01D 2258/012

(57) ABSTRACT

The present invention relates to a NOx adsorber diesel oxidation catalyst (NA-DOC) for the treatment of an exhaust gas, the catalyst comprising: a substrate comprising an inlet end, an outlet end, a substrate axial length extending from the inlet end to the outlet end and a plurality of passages defined by internal walls of the substrate extending therethrough; a NOx adsorber (NA) coating disposed on the surface of the internal walls of the substrate, said coating comprising a platinum group metal, a zeolitic material and one or more of an alkaline earth metal and manganese; and a diesel oxidation catalyst (DOC) coating, said coating comprising a platinum group metal supported on a non-zeolitic oxidic material.

The present invention relates to a NOx adsorber diesel oxidation catalyst, a process for preparing said catalyst and a use of said catalyst. Further, the present invention relates to an exhaust gas treatment system comprising said catalyst.

In the automotive industry, there is a continuous need to reduce NOx emissions from engines as these emissions are harmful for humans. Thus, it is important to cope with present legislations setting limits for NOx emissions. NOx adsorber diesel oxidation catalysts are thus used together with selective catalytic reduction catalysts.

During the treatment of an exhaust gas exiting an engine, NA-DOCs based on palladium/zeolite adsorb NOx at high efficiency rate during the so-called “cold-start” period, which is the time period at the beginning of the treatment process, when the exhaust gas stream and the exhaust gas treatment system are at low temperatures (i.e., below 150° C.). Said catalysts further release the NOx, when downstream SCR catalyst(s) starts to convert NOx. For example, it is known in the art that Pd/FER can be used as NOx adsorber (NA). However, at these low temperatures, exhaust gas treatment systems generally do not display sufficient catalytic activity for effectively treating hydrocarbons (HC), nitrogen oxides (NOx) and/or carbon monoxide (CO) emissions. In general, catalytic components such as SCR catalyst components are very effective in converting NOx to N₂ at temperatures above 200° C. but do not exhibit sufficient activities at lower temperature regions (<200° C.) such as those found during cold-start or prolonged low-speed city driving. In order to overcome such problems, a system comprising NOx adsorber diesel oxidation catalyst was described in WO 2020/236879 A1. However, there is still a need to provide a NOx adsorber diesel oxidation catalyst (NA-DOC) for the treatment of an exhaust gas, wherein the catalyst exhibits in particular an improved performance with respect to its NOx adsorption and/or desorption properties.

It was therefore an object of the present invention to provide a NOx adsorber diesel oxidation catalyst (NA-DOC) for the treatment of an exhaust gas, wherein the catalyst exhibits in particular an improved performance with respect to its NOx adsorption and/or desorption properties, in particular permits to maintain good NOx adsorption and delay the NOx desorption to higher targeted temperatures.

Surprisingly, it was found that the NOx adsorber diesel oxidation catalyst according to the present invention permits to maintain high and durable NOx adsorption and delay the NOx desorption to higher targeted temperatures. In particular, it was possible to shift the NOx desorption temperature towards higher temperatures from about 200° C. to about 300° C. which thus permit to have higher amount of NOx converted by a downstream SCR catalyst.

Therefore, the present invention relates to a NOx adsorber diesel oxidation catalyst (NA-DOC) for the treatment of an exhaust gas, the catalyst comprising:
(i) a substrate comprising an inlet end, an outlet end, a substrate axial length extending from the inlet end to the outlet end and a plurality of passages defined by internal walls of the substrate extending therethrough;
(ii) a NOx adsorber (NA) coating disposed on the surface of the internal walls of the substrate (i), said coating comprising a platinum group metal, a zeolitic material and one or more of an alkaline earth metal and manganese;
(iii) a diesel oxidation catalyst (DOC) coating, said coating comprising a platinum group metal supported on a non-zeolitic oxidic material.

Preferably the DOC coating extends over y % of the substrate axial length, with y being in the range of from 20 to 100 and the NA coating extends over x % of the substrate axial length, more preferably from the outlet end towards the inlet end of the substrate, with x being in the range of from 40 to 100.

Preferably the DOC coating is disposed on the NA coating and/or on the surface of the substrate axial length.

Preferably the platinum group metal comprised in the NA coating (ii) is selected from the group consisting of palladium, platinum, rhodium, iridium, osmium, ruthenium and a mixture of two or more thereof, more preferably selected from the group consisting of palladium, platinum and rhodium, more preferably selected from the group consisting of palladium and platinum, more preferably is palladium.

More preferably the platinum group metal comprised in the NA coating (ii) is palladium. More preferably the platinum group metal comprised in the NA coating (ii) is palladium and the NA coating (ii) is substantially free of, more preferably free of, platinum.

Preferably the NA coating (ii) comprises the platinum group metal at a loading, calculated as elemental platinum group metal, in the range of from 1 to 150 g/ft³, more preferably in the range of from 5 to 100 g/ft³, more preferably in the range of from 10 to 90 g/ft³, more preferably in the range of from 15 to 80 g/ft³, more preferably in the range of from 15 to 40 g/ft³, or more preferably in the range of from 50 to 80 g/ft³.

It is more preferred that the platinum group metal comprised in the NA coating (ii) is palladium which is present at a loading, calculated as elemental Pd, in the range of from 1 to 150 g/ft³, more preferably in the range of from 5 to 100 g/ft³, more preferably in the range of from 10 to 90 g/ft³, more preferably in the range of from 15 to 80 g/ft³, more preferably in the range of from 15 to 40 g/ft³, or more preferably in the range of from 50 to 80 g/ft³.

As to the zeolitic material comprised in the NA coating (ii), it is preferred that it is a 10-membered ring pore zeolitic material, wherein the 10-membered ring pore zeolitic material more preferably has framework type selected from the group consisting of FER, TON, MTT, SZR, MFI, MWW, AEL, HEU, AFO, a mixture of two or more thereof and a mixed type of two or more thereof, more preferably selected from the group consisting of FER, TON, MFI, MWW, AEL, HEU, AFO, a mixture of two or more thereof and a mixed type of two or more thereof, more preferably selected from the group consisting of FER and TON. It is more preferred that the 10-membered ring pore zeolitic material comprised in the NA coating (ii) has a framework type FER.

Preferably from 95 to 100 weight-%, more preferably from 98 to 100 weight-%, more preferably from 99 to 100 weight-%, more preferably from 99.5 to 100 weight-%, of the framework structure of the 10-membered ring pore zeolitic material comprised in the NA coating (ii) consist of Si, Al, and O. In the framework structure of the 10-membered ring pore zeolitic material, the molar ratio of Si to Al, calculated as molar SiO₂:Al₂O₃, more preferably is in the range of from 2:1 to 60:1, more preferably in the range of from 2:1 to 50:1, more preferably in the range of from 5:1 to 40:1, more preferably in the range of from 10:1 to 35:1, more preferably in the range of from 15:1 to 30:1, more preferably in the range of from 18:1 to 25:1.

Preferably the NA coating (ii) comprises the zeolitic material in an amount in the range of from 0.5 to 5 g/in³, more preferably in the range of from 1 to 4 g/in³, more preferably in the range of from 1.25 to 3 g/in³.

Preferably the zeolitic material comprised in the NA coating (ii) supports the platinum group metal. More preferably the zeolitic material comprised in the NA coating (ii) has a framework type FER or TON and supports palladium as the platinum group metal.

Preferably the NA coating (ii) comprises an alkaline earth metal, wherein the alkaline earth metal is more preferably selected from the group consisting of barium, strontium, calcium and magnesium, more preferably selected from the group consisting of barium, strontium and magnesium, more preferably is barium or strontium; or wherein the alkaline earth metal is barium and strontium, wherein more preferably the ratio of the weight of Ba, calculated as the oxide, relative to the weight of Sr, calculated as the oxide, is in the range of from 1:1 to 10:1, more preferably in the range of from 2:1 to 8:1, more preferably in the range of from 3:1 to 6:1.

Preferably the zeolitic material of the NA coating (ii) has a framework type FER or TON, more preferably FER, the platinum group metal of the NA coating (ii) is palladium. More preferably the zeolitic material of the NA coating (ii) has a framework type FER or TON, more preferably FER, the platinum group metal of the NA coating (ii) is palladium and the NA coating (ii) further comprises an alkaline earth metal as defined in the foregoing.

In the context of the present invention, the alkaline earth metal comprised in the NA coating (ii) is preferably present as oxides, cations and/or carbonates.

It is preferred that the NA coating (ii) comprises the alkaline earth metal in a total amount, calculated as the oxide, in the range of from 0.5 to 15 weight-%, more preferably in the range of from 1 to 10 weight-%, more preferably in the range of from 1.5 to 8 weight-%, based on the weight of the zeolitic material comprised in the NA coating (ii).

According to the present invention, it is more preferred that the NA coating (ii) comprises palladium, a 10-membered ring pore zeolitic material, more preferably a zeolitic material having a framework type FER, and barium. Alternatively, it is more preferred that the NA coating (ii) comprises palladium, a 10-membered ring pore zeolitic material, more preferably a zeolitic material having a framework type FER, and strontium.

Preferably the NA coating (ii) further comprises a non-zeolitic oxidic material, wherein the non-zeolitic oxidic material is selected from the group consisting of zirconia, alumina, silica, titania, ceria, a mixed oxide comprising one or more of Zr, Al, Si, Ti, and Ce and a mixture of two or more thereof, more preferably selected from the group consisting of zirconia, alumina, ceria and titania, more preferably selected from the group consisting of zirconia, alumina and ceria, more preferably is zirconia.

It is preferred that the NA coating (ii) comprises the non-zeolitic oxidic material in an amount in the range of from 1 to 30 weight-%, more preferably in the range of from 2 to 25 weight-%, more preferably in the range of from 4 to 21 weight-%, more preferably in the range of from 4 to 8 weight-% or more preferably in the range of from 18 to 21 weight-%, based on the weight of the zeolitic material comprised in the NA coating (ii).

Preferably the NA coating (ii) comprises manganese.

Preferably the zeolitic material of the NA coating (ii) has a framework type FER or TON, more preferably FER, the platinum group metal of the NA coating (ii) is palladium and the NA coating (ii) further comprises manganese.

It is preferred that the NA coating (ii) comprises manganese in an amount calculated as MnO₂, in the range of from 0.25 to 5 weight-%, more preferably in the range of from 0.5 to 3 weight-%, more preferably in the range of from 0.75 to 1.5 weight-% based on the weight of the zeolitic material comprised in the NA coating (ii).

Preferably the NA coating (ii) comprises barium and manganese.

Alternatively, the NA coating (ii) preferably comprises strontium and manganese.

Alternatively, the NA coating (ii) preferably comprises barium, strontium and manganese.

Preferably the zeolitic material of the NA coating (ii) has a framework type FER or TON, more preferably FER, the platinum group metal of the NA coating (ii) is palladium and the NA coating (ii) further comprises manganese and an alkaline earth metal, more preferably one or more of barium and strontium, more preferably barium or strontium or barium and strontium.

Preferably the NA coating (ii) further comprises an alkali metal, wherein the alkali metal is more preferably selected from the group consisting of sodium, potassium and lithium, wherein the alkali metal is more preferably sodium.

Preferably the NA coating (ii) comprises manganese and sodium.

Preferably the zeolitic material of the NA coating (ii) has a framework type FER or TON, more preferably FER, the platinum group metal of the NA coating (ii) is palladium and the NA coating (ii) further comprises manganese and an alkali metal, more preferably sodium.

Preferably the NA coating (ii) comprises the alkali metal in an amount, calculated as the oxide, in the range of from 0.1 to 4 weight-%, more preferably in the range of from 0.25 to 3 weight-%, more preferably in the range of from 0.5 to 2 weight-%, based on the weight of the zeolitic material comprised in the NA coating (ii).

Preferably the NA coating (ii) comprises sodium in an amount, calculated as NaO, in the range of from 0.1 to 4 weight-%, more preferably in the range of from 0.25 to 3 weight-%, more preferably in the range of from 0.5 to 2 weight-%, more preferably in the range of from 0.5 to 1 weight-%, based on the weight of the zeolitic material comprised in the NA coating (ii). Alternatively, the NA coating (ii) preferably comprises potassium in an amount, calculated as K₂O, in the range of from 0.1 to 4 weight-%, more preferably in the range of from 0.25 to 3 weight-%, more preferably in the range of from 0.5 to 2 weight-%, more preferably in the range of from 1.2 to 2 weight-%, based on the weight of the zeolitic material comprised in the NA coating (ii).

In the context of the present invention, it is preferred that the NA coating (ii) further comprises one or more of Nd, La, Ce, Pr, Sm, Y and Yb, preferably one or more of Nd and Pr, more preferably Nd. It is preferred that the NA coating (ii) comprises the one or more of Nd, La, Ce, Pr, Sm, Y and Yb, in an amount, calculated as the oxide, in the range of from 2 to 6 weight-%, more preferably in the range of from 3 to 5 weight-%, more preferably in the range of from 4 to 5 weight-% based on the weight of the zeolitic material comprised in the NA coating (ii).

Preferably, the NA coating (ii) comprises palladium, the zeolitic material, more preferably having a framework type FER, barium, and more preferably a non-zeolitic oxidic material as defined in the foregoing. More preferably from 99 to 100 weight-%, more preferably from 99.5 to 100 weight-%, more preferably from 99.9 to 100 weight-%, of the NA coating (ii) consists of the platinum group metal, more preferably palladium, the zeolitic material, more preferably having a framework type FER, barium, and more preferably a non-zeolitic oxidic material as defined in the foregoing.

Alternatively, preferably the NA coating (ii) comprises palladium, the zeolitic material, more preferably having a framework type FER, strontium and more preferably a non-zeolitic oxidic material as defined in the foregoing. More preferably from 99 to 100 weight-%, more preferably from 99.5 to 100 weight-%, more preferably from 99.9 to 100 weight-%, of the NA coating (ii) consists of the platinum group metal, more preferably palladium, the zeolitic material, more preferably having a framework type FER, strontium and more preferably a non-zeolitic oxidic material as defined in the foregoing.

Alternatively, preferably, the NA coating (ii) comprises palladium, the zeolitic material, more preferably having a framework type FER, manganese, an alkaline earth metal, more preferably barium or strontium, and more preferably a non-zeolitic oxidic material as defined in the foregoing. More preferably from 99 to 100 weight-%, more preferably from 99.5 to 100 weight-%, more preferably from 99.9 to 100 weight-%, of the NA coating (ii) consists of the platinum group metal, more preferably palladium, the zeolitic material, more preferably having a framework type FER, manganese, an alkaline earth metal, more preferably barium or strontium, and more preferably a non-zeolitic oxidic material as defined in the foregoing.

Alternatively, preferably, the NA coating (ii) comprises palladium, the zeolitic material, more preferably having a framework type FER, manganese, barium, strontium, and more preferably a non-zeolitic oxidic material as defined in the foregoing. More preferably from 99 to 100 weight-%, more preferably from 99.5 to 100 weight-%, more preferably from 99.9 to 100 weight-%, of the NA coating (ii) consists of the platinum group metal, more preferably palladium, the zeolitic material, more preferably having a framework type FER, manganese, barium, strontium and more preferably a non-zeolitic oxidic material as defined in the foregoing.

Alternatively, preferably, the NA coating (ii) comprises palladium, the zeolitic material, more preferably having a framework type FER, manganese, an alkali metal, more preferably sodium, as defined in the foregoing, and more preferably a non-zeolitic oxidic material as defined in the foregoing. More preferably from 99 to 100 weight-%, more preferably from 99.5 to 100 weight-%, more preferably from 99.9 to 100 weight-%, of the NA coating (ii) consists of the platinum group metal, more preferably palladium, the zeolitic material, more preferably having a framework type FER, manganese, an alkali metal, more preferably sodium, as defined in the foregoing, and more preferably a non-zeolitic oxidic material as defined in the foregoing.

Alternatively, preferably, the NA coating (ii) comprises palladium, the zeolitic material, more preferably having a framework type FER, an alkaline earth metal, more preferably barium or strontium, and one or more of Nd, La, Ce, Pr, Sm, Y and Yb, and more preferably a non-zeolitic oxidic material as defined in the foregoing. More preferably from 99 to 100 weight-%, more preferably from 99.5 to 100 weight-%, more preferably from 99.9 to 100 weight-%, of the NA coating (ii) consists of the platinum group metal, more preferably palladium, the zeolitic material, more preferably having a framework type FER, an alkaline earth metal, more preferably barium or strontium, and one or more of Nd, La, Ce, Pr, Sm, Y and Yb, and more preferably a non-zeolitic oxidic material as defined in the foregoing.

Alternatively, preferably, the NA coating (ii) comprises palladium, the zeolitic material, more preferably having a framework type FER, manganese, and more preferably a non-zeolitic oxidic material as defined in the foregoing. More preferably from 99 to 100 weight-%, more preferably from 99.5 to 100 weight-%, more preferably from 99.9 to 100 weight-%, of the NA coating (ii) consists of the platinum group metal, more preferably palladium, the zeolitic material, more preferably having a framework type FER, manganese, and more preferably a non-zeolitic oxidic material as defined in the foregoing.

In the context of the present invention, it is preferred that the platinum group metal comprised in the DOC coating (iii) is selected from the group consisting of palladium, platinum, rhodium, iridium, osmium, ruthenium and a mixture of two or more thereof, more preferably selected from the group consisting of palladium, platinum and rhodium, more preferably selected from the group consisting of palladium and platinum, more preferably is platinum. In this regard, it is also conceivable that the platinum group metal comprised in the DOC coating (iii) be preferably platinum and palladium.

Preferably the DOC coating (iii) comprises the platinum group metal component at a loading, calculated as elemental platinum group metal, in the range of from 1 to 150 g/ft³, more preferably in the range of from 10 to 100 g/ft³, more preferably in the range of from 20 to 90 g/ft³, more preferably in the range of from 30 to 80 g/ft³, more preferably in the range of from 40 to 80 g/ft³.

Preferably the non-zeolitic oxidic material comprised in the DOC coating (iii) comprises one or more of alumina, silica, zirconia and titania, more preferably one or more of alumina, silica and zirconia, more preferably alumina.

More preferably from 70 to 99 weight-%, more preferably from 80 to 98 weight-%, more preferably from 90 to 97 weight-%, more preferably from 92 to 97 weight-%, of the non-zeolitic oxidic material comprised in the DOC coating (iii) consists of alumina. It is more preferred that from 1 to 30 weight-%, more preferably from 2 to 20 weight-%, more preferably from 3 to 10 weight-%, more preferably from 3 to 8 weight-%, of the non-zeolitic oxidic material comprised in the DOC coating (iii) consists of silicon, calculated as SiO₂.

Alternatively, preferably from 70 to 99 weight-%, preferably from 80 to 98 weight-%, more preferably from 90 to 97 weight-%, more preferably from 92 to 97 weight-%, of the non-zeolitic oxidic material comprised in the DOC coating (iii) consists of alumina, and more preferably wherein from 1 to 30 weight-%, more preferably from 2 to 20 weight-%, more preferably from 3 to 10 weight-%, more preferably from 3 to 8 weight-%, of the non-zeolitic oxidic material comprised in the DOC coating (iii) consists of manganese, calculated as MnO₂.

Preferably the DOC coating (iii) further comprises a zeolitic material comprising one or more of iron and copper, preferably a zeolitic material comprising iron. More preferably the DOC coating (iii) comprises iron in an amount, calculated as Fe₂O₃, in the range of from 1 to 10 weight-%, more preferably in the range of from 2 to 8 weight-%, more preferably in the range of from 3 to 5 weight-%, based on the weight of the zeolitic material comprising iron comprised in the DOC coating (iii).

Alternatively, preferably the DOC coating (iii) further comprises a zeolitic material in its H-form. This means in the context of the present invention that the zeolitic material is not ion-exchanged with a metal, such as Cu or Fe.

In the context of the present invention, it is preferred that the zeolitic material comprised in the DOC coating (iii) is a 12-membered ring pore zeolitic material, wherein said zeolitic material more preferably has a framework type selected from the group consisting of BEA, MOR, FAU, GME, OFF a mixture of two or more thereof and a mixed type of two or more thereof, more preferably selected from the group consisting of BEA, MOR, FAU, a mixture of two or more thereof and a mixed type of two or more thereof, more preferably selected from the group consisting of BEA and FAU. It is more preferred that the 12-membered ring pore zeolitic material comprised in the DOC coating (iii) has a framework type BEA.

Preferably from 95 to 100 weight-%, more preferably from 98 to 100 weight-%, more preferably from 99 to 100 weight-%, more preferably from 99.5 to 100 weight-%, of the framework structure of the 12-membered ring pore zeolitic material comprised in the DOC coating (iii) consist of Si, Al, and O. In the framework structure of the 12-membered ring pore zeolitic material comprised in the DOC coating (iii), the molar ratio of Si to Al, calculated as molar SiO₂:Al₂O₃, is preferably in the range of from 2:1 to 60:1, more preferably in the range of from 2:1 to 50:1, more preferably in the range of from 5:1 to 40:1, more preferably in the range of from 10:1 to 35:1, more preferably in the range of from 15:1 to 30:1, more preferably in the range of from 20:1 to 27:1.

Preferably the weight ratio of the non-zeolitic oxidic material comprised in the DOC coating (iii) relative to the zeolitic material comprised in the DOC coating (iii) is in the range of from 1.5:1 to 10:1, more preferably in the range of from 2:1 to 8:1, more preferably in the range of from 2.5:1 to 6:1, more preferably in the range of from 3:1 to 5:1.

Preferably the DOC coating (iii) comprises the non-zeolitic oxidic material in an amount in the range of from 0.75 to 3 g/in³, more preferably in the range of from 1 to 2 g/in³.

Preferably the NA coating disposed on the surface of the internal walls of the substrate (i) extends over x % of the substrate axial length, more preferably from the outlet end towards the inlet end, with x being in the range of from 40 to 100.

It is preferred that x is in the range of from 98 to 100, more preferably in the range of from 99 to 100.

Preferably the DOC coating (iii) has a single coat.

Preferably the DOC coating extends over y % of the substrate axial length, more preferably from the inlet end towards the outlet end of the substrate, with y being in the range of from 20 to 100.

It is more preferred that y is in the range of from 98 to 100, preferably in the range of from 99 to 100. It is more preferred that x is in the range of from 98 to 100, more preferably in the range of from 99 to 100, and that y is in the range of from 98 to 100, more preferably in the range of from 99 to 100.

Alternatively, it is preferred that x is in the range of from 40 to 60, more preferably in the range of from 45 to 55.

It is preferred that y is in the range of from 30 to 60, more preferably in the range of from 45 to 55, more preferably y=100−x. It is more preferred that x is in the range of from 40 to 60, more preferably in the range of from 45 to 55 and that y is in the range of from 30 to 60, more preferably in the range of from 45 to 55, more preferably y=100−x. Thus, in this configuration, the two coatings preferably do not overlap.

As to x, it is preferred that it is in the range of from 98 to 100, preferably in the range of from 99 to 100 and that y is in the range of from 20 to 40, preferably in the range of from 25 to 35.

As to x, it is preferred alternatively that it is in the range of from 40 to 90, preferably in the range of from 45 to 80.

It is preferred that y is in the range of from 50 to 100. It is more preferred that x is in the range of from 40 to 90, preferably in the range of from 45 to 80, and that y is in the range of from 50 to 100.

It is alternatively preferred that the DOC coating extends over y % of the substrate axial length from the outlet end towards the inlet end, with y being in the range of from 20 to 60, more preferably in the range of from 20 to 40. More preferably x is in the range of from 98 to 100, more preferably in the range of from 99 to 100 and y is in the range of from 20 to 60, more preferably in the range of from 20 to 40. In this configuration, it is more preferred that the substrate according to (i) is heated.

In the context of the present invention, the DOC coating (iii) preferably has a single coat.

Alternatively, it is preferred that the DOC coating (iii) comprises, more preferably consists of,
(iii.1) an inlet coat comprising the platinum group metal, more preferably platinum, the non-zeolitic oxidic material and a zeolitic material as defined in the foregoing; and
(iii.2) an outlet coat comprising the platinum group metal, more preferably platinum, and the non-zeolitic oxidic material;
wherein the inlet coat (iii.1) extends over y1% of the substrate axial length from the inlet end towards the outlet end of the substrate according to (i), wherein y1 is in the range of from 20 to 80, more preferably in the range of from 30 to 60, more preferably in the range of from 45 to 55, and
wherein the outlet coat (iii.2) extends over y2% of the substrate axial length from the outlet end towards the inlet end of the substrate according to (i), wherein y2 is in the range of from 20 to 80, more preferably in the range of from 30 to 60, more preferably in the range of from 45 to 55.

It is preferred that the DOC coating extends over y % of the substrate axial length, more preferably from the inlet end towards the outlet end, with y being in the range of from 98 to 100, more preferably in the range of from 99 to 100.

In the context of the present invention, it is noted that the inlet coat and the outlet coat are different chemically and physically from one another. Indeed, this is obvious for the skilled person, as, should both coats be the same, they would not be distinguishable from one another.

Preferably the inlet coat (iii.1) is disposed on the NA coating, and the outlet coat (iii.2) is disposed on the NA coating, wherein y2 is y−y1.

Preferably the inlet coat (iii.1) comprises, in addition to platinum, palladium, wherein the weight ratio of Pt to Pd, calculated as elemental Pt and Pd, respectively, more preferably is in the range of from 1:1 to 10:1, more preferably in the range of from 1.1:1 to 8:1, more preferably in the range of from 1.5:1 to 4:1.

Preferably the inlet coat (iii.1) comprises platinum at a Pt loading, calculated as elemental Pt, and palladium at a Pd loading, calculated as elemental Pd, wherein the sum of the Pt loading and the Pd loading is in the range of from 5 to 40 g/ft³, more preferably in the range of from 10 to 30 g/ft³.

Preferably the weight ratio of the non-zeolitic oxidic material comprised in the inlet coat (iii.1) relative to the zeolitic material comprised in the inlet coat (iii.1) is in the range of from 0.25:1 to 4:1, more preferably in the range of from 0.5:1 to 2:1, more preferably in the range of from 0.75:1 to 1.5:1.

Preferably the outlet coat (iii.2) comprises platinum at a loading, calculated as elemental Pt, in the range of from 50 to 100 g/ft³, more preferably in the range of from 70 to 90 g/ft³.

Thus, the present invention according to a certain aspect preferably relates to a NOx adsorber diesel oxidation catalyst (NA-DOC) for the treatment of an exhaust gas, the catalyst comprising:
(i) a substrate comprising an inlet end, an outlet end, a substrate axial length extending from the inlet end to the outlet end and a plurality of passages defined by internal walls of the substrate extending therethrough;
(ii) a NOx adsorber (NA) coating disposed on the surface of the internal walls of the substrate (i), said coating comprising a platinum group metal, more preferably palladium, a zeolitic material having a framework type FER or TON, more preferably FER, manganese and an alkaline earth metal, more preferably barium;
(iii) a diesel oxidation catalyst (DOC) coating, said coating comprising a platinum group metal supported on a non-zeolitic oxidic material; wherein the DOC coating (iii) comprises, more preferably consists of,
   (iii.1) an inlet coat comprising the platinum group metal, more preferably platinum, more preferably palladium is comprised in the inlet coat in addition to platinum, the non-zeolitic oxidic material and a zeolitic material as defined in the foregoing, more preferably having a framework type BEA; and
   (iii.2) an outlet coat comprising the platinum group metal, more preferably platinum, and the non-zeolitic oxidic material;
   wherein the inlet coat (iii.1) extends over y1% of the substrate axial length from the inlet end towards the outlet end of the substrate according to (i), wherein y1 is in the range of from 20 to 80, more preferably in the range of from 30 to 60, more preferably in the range of from 45 to 55, and
   wherein the outlet coat (iii.2) extends over y2% of the substrate axial length from the outlet end towards the inlet end of the substrate according to (i), wherein y2 is in the range of from 20 to 80, more preferably in the range of from 30 to 60, more preferably in the range of from 45 to 55.

It is more preferred that the DOC coating extends over y % of the substrate axial length, more preferably from the inlet end towards the outlet end, with y being in the range of from 98 to 100, more preferably in the range of from 99 to 100 and that the NA coating extends over x % of the substrate axial length, more preferably from the inlet end towards the outlet end, with y being in the range of from 98 to 100, more preferably in the range of from 99 to 100.

Further, the present invention according to a further aspect preferably relates to a NOx adsorber diesel oxidation catalyst (NA-DOC) for the treatment of an exhaust gas, the catalyst comprising:
(i) a substrate comprising an inlet end, an outlet end, a substrate axial length extending from the inlet end to the outlet end and a plurality of passages defined by internal walls of the substrate extending therethrough;
(ii) a NOx adsorber (NA) coating disposed on the surface of the internal walls of the substrate (i), said coating comprising a platinum group metal, more preferably palladium, a zeolitic material having a framework type FER or TON, more preferably FER, the NA coating further comprising
   manganese and an alkaline earth metal or an alkali metal, more preferably manganese is used in addition to Ba, Sr or Na; or
   manganese and one or more of Ba and Sr, more preferably Mn, Ba and Sr;
   an alkaline earth metal, more preferably Ba or Sr;
(iii) a diesel oxidation catalyst (DOC) coating, said coating comprising a platinum group metal, more preferably platinum, supported on a non-zeolitic oxidic material, more preferably alumina, more preferably the DOC coating consists of one single coat.

It is more preferred that the DOC coating extends over y % of the substrate axial length, more preferably from the inlet end towards the outlet end, with y being in the range of from 98 to 100, more preferably in the range of from 99 to 100 and that the NA coating extends over x % of the substrate axial length, more preferably from the inlet end towards the outlet end, with y being in the range of from 98 to 100, more preferably in the range of from 99 to 100.

Further, the present invention according to a further aspect preferably relates to a NOx adsorber diesel oxidation catalyst (NA-DOC) for the treatment of an exhaust gas, the catalyst comprising:
(i) a substrate comprising an inlet end, an outlet end, a substrate axial length extending from the inlet end to the outlet end and a plurality of passages defined by internal walls of the substrate extending therethrough;
(ii) a NOx adsorber (NA) coating disposed on the surface of the internal walls of the substrate (i), said coating comprising a platinum group metal, more preferably palladium, a zeolitic material having a framework type FER or TON, more preferably FER, the NA coating further comprising
   manganese;
   manganese and an alkaline earth metal, more preferably Ba; or
   an alkaline earth metal, more preferably Ba or Sr;
(iii) a diesel oxidation catalyst (DOC) coating, said coating comprising a platinum group metal supported on a non-zeolitic oxidic material; wherein the DOC coating (iii) comprises, more preferably consists of,
   (iii.1) an inlet coat comprising the platinum group metal, more preferably platinum, more preferably palladium is comprised in the inlet coat in addition to platinum, the non-zeolitic oxidic material and a zeolitic material as defined in the foregoing, more preferably having a framework type BEA; and
   (iii.2) an outlet coat comprising the platinum group metal, more preferably platinum, and the non-zeolitic oxidic material;
   wherein the inlet coat (iii.1) extends over y1% of the substrate axial length from the inlet end towards the outlet end of the substrate according to (i), wherein y1 is in the range of from 20 to 80, more preferably in the range of from 30 to 60, more preferably in the range of from 45 to 55, and
   wherein the outlet coat (iii.2) extends over y2% of the substrate axial length from the outlet end towards the inlet end of the substrate according to (i), wherein y2 is in the range of from 20 to 80, more preferably in the range of from 30 to 60, more preferably in the range of from 45 to 55.

It is more preferred that the DOC coating extends over y % of the substrate axial length, more preferably from the inlet end towards the outlet end, with y being in the range of from 98 to 100, more preferably in the range of from 99 to 100 and that the NA coating extends over x % of the substrate axial length, more preferably from the inlet end towards the outlet end, with y being in the range of from 98 to 100, more preferably in the range of from 99 to 100.

Preferably, in the context of the present invention, the flow-through substrate (i) comprises, more preferably consists of, a ceramic substance, wherein the ceramic substance more preferably comprises, more preferably consists of, one or more of an alumina, a silica, a silicate, an aluminosilicate, more preferably a cordierite or a mullite, an aluminotitanate, a silicon carbide, a zirconia, a magnesia, more preferably a spinel, and a titania, more preferably one or more of a silicon carbide and a cordierite, more preferably a cordierite.

Alternatively, preferably the flow-through substrate (i) comprises, more preferably consists of, a metallic substance, wherein the metallic substance more preferably comprises, more preferably consists of, oxygen and one or more of iron, chromium and aluminum. Preferably the substrate is electrically heated.

Preferably the catalyst of the present invention consists of the substrate (i), the NA coating (ii) and the DOC coating (iii).

The present invention further relates to a process for preparing a NOx adsorber diesel oxidation catalyst (NA-DOC), preferably the NOx adsorber diesel oxidation catalyst (NA-DOC) according to the present invention and as defined in the foregoing, comprising
(a) preparing a first mixture comprising water, a source of a platinum group metal, a zeolitic material and a source of one or more of an alkaline earth metal and manganese;
(b) disposing the first mixture obtained according to (a) on the surface of the internal walls of a substrate comprising an inlet end, an outlet end, a substrate axial length extending from the inlet end to the outlet end and a plurality of passages defined by internal walls of the substrate extending therethrough; calcining, obtaining a substrate having a NA coating thereon;
(c) preparing a second mixture comprising water, a source of a platinum group metal and a non-zeolitic oxidic material;
(d) disposing the second mixture obtained according to (c) on the substrate having a NA coating thereon;
(e) calcining the substrate obtained according to (d), obtaining a substrate having a NA coating and a DOC coating thereon.

As to (a), it is preferred that it comprises
(a.1) admixing, more preferably impregnating, the zeolitic material, more preferably in its ammonium form, with the source of a platinum group metal, more preferably a source of palladium, more preferably palladium nitrate, and the source of one or more of an alkaline earth metal and manganese;
(a.2) dispersing the admixed zeolitic material in water;
(a.3) more preferably adding a precursor of a non-zeolitic oxidic material, more preferably a precursor of zirconium, more preferably zirconium acetate.

Preferably the source of the one or more of an alkaline earth metal and manganese is one or more of a nitrate, an acetate and an hydroxide, wherein more preferably the source of the one or more of an alkaline earth metal and manganese are selected from the group consisting of strontium acetate, strontium nitrate, barium hydroxide, barium nitrate, manganese nitrate, manganese acetate, and a mixture of two or more thereof, more preferably selected from the group consisting of strontium acetate, barium hydroxide, barium nitrate, manganese nitrate and a mixture of two or more thereof.

Preferably disposing the first mixture in (b) comprises disposing the first mixture obtained in (a) from the outlet end towards to the inlet end of the substrate over x % of the substrate axial length, wherein x is in the range of from 40 to 100; wherein more preferably x is in the range of from 98 to 100, more preferably in the range of from 99 to 100; or wherein more preferably x is in the range of from 40 to 90, more preferably in the range of from 45 to 80.

Preferably calcining according to (b) is performed in a gas atmosphere having a temperature in the range of from 400 to 800° C., more preferably in the range of from 450 to 700° C., more preferably in the range of from 550 to 650° C., the gas atmosphere more preferably comprising one or more of oxygen and nitrogen, more preferably air.

Preferably calcining according to (b) is performed in a gas atmosphere for a duration in the range of from 0.5 to 5 hours, more preferably in the range of from 1.5 to 2.5 hours, the gas atmosphere more preferably comprising one or more of oxygen and nitrogen, more preferably air.

Preferably, prior to calcining according to (b), drying of the coated substrate is performed in a gas atmosphere having a temperature in the range of from 90 to 150° C., more preferably in the range of from 100 to 120° C., the gas atmosphere more preferably being air.

Preferably, prior to calcining according to (b), drying of the coated substrate is performed in a gas atmosphere for a duration in the range of from 0.5 to 4 hours, more preferably in the range of from 0.75 to 2 hours, the gas atmosphere more preferably comprising one or more of oxygen and nitrogen, more preferably air.

Preferably (c) comprises
(c.1) admixing, preferably impregnating, a non-zeolitic oxidic material, preferably as defined in the foregoing, with a source of a platinum group metal;
(c.2) dispersing the admixed, more preferably impregnated, non-zeolitic oxidic material in water.

More preferably (c) further comprises
(c.3) admixing a zeolitic material comprising one or more of iron and copper, preferably a zeolitic material comprising iron, to the dispersion obtained according to (c.2), obtaining the second mixture,
wherein the zeolitic material preferably is as defined in the foregoing.

Preferably disposing the second mixture in (d) comprises disposing the second mixture obtained in (c) from the inlet end towards to the outlet end of the substrate over y % of the substrate axial length, wherein y is in the range of from 20 to 100; wherein more preferably y is in the range of from 98 to 100, preferably in the range of from 99 to 100; or wherein y is in the range of from 30 to 60, more preferably in the range of from 45 to 55, more preferably y=100−x. It is also conceivable that the second mixture obtained in (c) be preferably disposed from the outlet end towards the inlet end of the substrate.

Preferably disposing the second mixture in (d) comprises disposing the second mixture obtained in (c) from the inlet end towards to the outlet end of the substrate over y1% of the substrate axial length, wherein y1 is in the range of from 20 to 80, more preferably from 30 to 60, more preferably from 45 to 55.

Preferably (d) further comprising, prior to calcining according to (e),
preparing a third mixture comprising water and a source of a platinum group metal and a non-zeolitic oxidic material;
disposing the third mixture on the substrate from the outlet end towards to the inlet end of the substrate over y2% of the substrate axial length, wherein y2 is in the range of from 20 to 80, more preferably from 30 to 60, more preferably from 45 to 55, more preferably y2 is 100−y1, and optionally drying.

Preferably calcining according to (e) is performed in a gas atmosphere having a temperature in the range of from 400 to 800° C., more preferably in the range of from 450 to 700° C., more preferably in the range of from 550 to 650° C., the gas atmosphere more preferably comprising one or more of oxygen and nitrogen, more preferably air.

Preferably calcining according to (e) is performed in a gas atmosphere for a duration in the range of from 0.5 to 5 hours, more preferably in the range of from 1.5 to 2.5 hours, the gas atmosphere more preferably comprising one or more of oxygen and nitrogen, more preferably air.

Preferably, prior to calcining according to (e), drying of the coated substrate is performed in a gas atmosphere having a temperature in the range of from 90 to 150° C., more preferably in the range of from 100 to 120° C., the gas atmosphere more preferably being air.

Preferably, prior to calcining according to (e), drying of the coated substrate is performed in a gas atmosphere for a duration in the range of from 0.5 to 4 hours, more preferably in the range of from 0.75 to 2 hours, the gas atmosphere more preferably comprising one or more of oxygen and nitrogen, more preferably air.

Preferably the process consists of (a), (b), (c), (d) and (e).

The present invention further relates to a NOx adsorber diesel oxidation catalyst (NA-DOC), preferably the NA-DOC catalyst according to the present invention and as defined in the foregoing, obtained or obtainable by a process according to the present invention and as defined in the foregoing.

The present invention further relates to a use of a NOx adsorber diesel oxidation catalyst (NA-DOC) according to the present invention and as defined in the foregoing for the NOx adsorption/desorption and the conversion of HC and CO.

The present invention further relates to an exhaust treatment system for the treatment of an exhaust gas, the system comprising
a NOx adsorber diesel oxidation (NA-DOC) catalyst according to the present invention and as defined in the foregoing;
the system preferably further comprises one or more of a selective catalytic reduction catalyst (SCR), a selective catalytic reduction catalyst on a filter (SCRoF) and an ammonia oxidation (AMOX) catalyst,
wherein the NA-DOC catalyst is preferably located upstream of the one or more of a selective catalytic reduction catalyst (SCR), a selective catalytic reduction catalyst on a filter (SCRoF) and an ammonia oxidation (AMOX) catalyst.

Preferably the system further comprises a selective catalytic reduction catalyst (SCR) and an ammonia oxidation (AMOX) catalyst, wherein the NA-DOC catalyst is located upstream of the selective catalytic reduction catalyst (SCR) and the SCR catalyst is located upstream of the ammonia oxidation (AMOX) catalyst, wherein more preferably no catalyst for treating the exhaust gas stream exiting the NA-DOC catalyst and upstream of the SCR catalyst is located in the exhaust gas treatment system.

Alternatively, preferably the system further comprises a selective catalytic reduction catalyst on a filter (SCRoF) and an ammonia oxidation (AMOX) catalyst, wherein the NA-DOC catalyst is located upstream of the selective catalytic reduction catalyst on a filter (SCRoF) and the SCRoF catalyst is located upstream of the ammonia oxidation (AMOX) catalyst, wherein more preferably no catalyst for treating the exhaust gas stream exiting the NA-DOC catalyst and upstream of the SCRoF catalyst is located in the exhaust gas treatment system.

Alternatively, preferably the system further comprises a selective catalytic reduction catalyst on a filter (SCRoF), a selective catalytic reduction catalyst (SCR) and an ammonia oxidation (AMOX) catalyst, wherein the NA-DOC catalyst is located upstream of the selective catalytic reduction catalyst on a filter (SCRoF), the SCRoF catalyst is located upstream of the SCR catalyst, and the SCR catalyst is located upstream of the AMOX catalyst, wherein preferably no catalyst for treating the exhaust gas stream exiting the NA-DOC catalyst and upstream of the SCRoF catalyst is located in the exhaust gas treatment system.

Preferably the system further comprises a first electrically heated substrate, wherein the NA-DOC catalyst is located downstream of said first electrically heated substrate.

Preferably the system further comprises a second electrically heated substrate, wherein the NA-DOC catalyst is located downstream of said second electrically heated substrate.

The present invention further relates to a method for the treatment of an exhaust gas comprising
providing an exhaust gas, preferably from an internal combustion engine, more preferably from a diesel engine;
contacting the exhaust gas with a NOx adsorber diesel oxidation catalyst according to the present invention and as defined in the foregoing.

The present invention is further illustrated by the following set of embodiments and combinations of embodiments resulting from the dependencies and back-references as indicated. In particular, it is noted in the context of the present invention, that in each instance where a range of embodiments is mentioned, for example in the context of a term such as “The catalyst of any one of embodiments 1 to 5”, every embodiment in this range is meant to be explicitly disclosed for the skilled person, i.e. the wording of this term is to be understood by the skilled person as being synonymous to “The catalyst of any one of embodiments 1, 2, 3, 4 and 5”. Further, it is explicitly noted that the following set of embodiments is not the set of claims determining the extent of protection, but represents a suitably structured part of the description directed to general and preferred aspects of the present invention. It is noted that this is applicable as well for the second set of embodiments.

1. A NOx adsorber diesel oxidation catalyst (NA-DOC) for the treatment of an exhaust gas, the catalyst comprising:
(i) a substrate comprising an inlet end, an outlet end, a substrate axial length extending from the inlet end to the outlet end and a plurality of passages defined by internal walls of the substrate extending therethrough;
(ii) a NOx adsorber (NA) coating disposed on the surface of the internal walls of the substrate (i), said coating comprising a platinum group metal, a zeolitic material and one or more of an alkaline earth metal and manganese;
(iii) a diesel oxidation catalyst (DOC) coating, said coating comprising a platinum group metal supported on a non-zeolitic oxidic material.

2. The catalyst of embodiment 1, wherein the platinum group metal comprised in the NA coating (ii) is selected from the group consisting of palladium, platinum, rhodium, iridium, osmium, ruthenium and a mixture of two or more thereof, preferably selected from the group consisting of palladium, platinum and rhodium, more preferably selected from the group consisting of palladium and platinum, more preferably is palladium.

3. The catalyst of embodiment 1 or 2, wherein the NA coating (ii) comprises the platinum group metal at a loading, calculated as elemental platinum group metal, in the range of from 1 to 150 g/ft³, preferably in the range of from 5 to 100 g/ft³, more preferably in the range of from 10 to 90 g/ft³, more preferably in the range of from 15 to 80 g/ft³, more preferably in the range of from 15 to 40 g/ft³, or more preferably in the range of from 50 to 80 g/ft³.

4. The catalyst of any one of embodiments 1 to 3, wherein the zeolitic material comprised in the NA coating (ii) is a 10-membered ring pore zeolitic material, wherein the 10-membered ring pore zeolitic material preferably has framework type selected from the group consisting of FER, TON, MTT, SZR, MFI, MWW, AEL, HEU, AFO, a mixture of two or more thereof and a mixed type of two or more thereof, more preferably selected from the group consisting of FER, TON, MFI, MWW, AEL, HEU, AFO, a mixture of two or more thereof and a mixed type of two or more thereof, more preferably selected from the group consisting of FER and TON, wherein more preferably the 10-membered ring pore zeolitic material comprised in the NA coating (ii) has a framework type FER.

5. The catalyst of embodiment 4, wherein from 95 to 100 weight-%, preferably from 98 to 100 weight-%, more preferably from 99 to 100 weight-%, more preferably from 99.5 to 100 weight-%, of the framework structure of the 10-membered ring pore zeolitic material comprised in the NA coating (ii) consist of Si, Al, and O, wherein in the framework structure, the molar ratio of Si to Al, calculated as molar SiO₂:Al₂O₃, is more preferably in the range of from 2:1 to 60:1, more preferably in the range of from 2:1 to 50:1, more preferably in the range of from 5:1 to 40:1, more preferably in the range of from 10:1 to 35:1, more preferably in the range of from 15:1 to 30:1, more preferably in the range of from 18:1 to 25:1.

6. The catalyst of any one of embodiments 1 to 5, wherein the NA coating (ii) comprises the zeolitic material in an amount in the range of from 0.5 to 5 g/in³, preferably in the range of from 1 to 4 g/in³, more preferably in the range of from 1.25 to 3 g/in³.

7. The catalyst of any one of embodiments 1 to 6, wherein the NA coating (ii) comprises an alkaline earth metal, wherein the alkaline earth metal is preferably selected from the group consisting of barium, strontium, calcium and magnesium, more preferably selected from the group consisting of barium, strontium and magnesium, more preferably is barium or strontium; or
wherein the alkaline earth metal is barium and strontium, wherein more preferably the ratio of the weight of Ba, calculated as the oxide, relative to the weight of Sr, calculated as the oxide, is in the range of from 1:1 to 10:1, more preferably in the range of from 2:1 to 8:1, more preferably in the range of from 3:1 to 6:1.

8. The catalyst of any one of embodiments 1 to 7, wherein the NA coating (ii) comprises the alkaline earth metal in a total amount, calculated as the oxide, in the range of from 0.5 to 15 weight-%, preferably in the range of from 1 to 10 weight-%, more preferably in the range of from 1.5 to 8 weight-%, based on the weight of the zeolitic material comprised in the NA coating (ii).

9. The catalyst of any one of embodiments 1 to 8, wherein the NA coating (ii) further comprises a non-zeolitic oxidic material, wherein the non-zeolitic oxidic material is selected from the group consisting of zirconia, alumina, silica, titania, ceria, a mixed oxide comprising one or more of Zr, Al, Si, Ti, and Ce and a mixture of two or more thereof, preferably selected from the group consisting of zirconia, alumina, ceria and titania, more preferably selected from the group consisting of zirconia, alumina and ceria, more preferably is zirconia.

10. The catalyst of embodiment 10, wherein the NA coating (ii) comprises the non-zeolitic oxidic material in an amount in the range of from 1 to 30 weight-%, preferably in the range of from 2 to 25 weight-%, more preferably in the range of from 4 to 21 weight-%, based on the weight of the zeolitic material comprised in the NA coating (ii).

11. The catalyst of any one of embodiments 1 to 10, wherein the NA coating (ii) comprises manganese, wherein the NA coating (ii) preferably comprises manganese in an amount calculated as MnO₂, in the range of from 0.25 to 5 weight-%, more preferably in the range of from 0.5 to 3 weight-%, more preferably in the range of from 0.75 to 1.5 weight-% based on the weight of the zeolitic material comprised in the NA coating (ii).

12. The catalyst of any one of embodiments 7 to 11, wherein the NA coating (ii) comprises barium and manganese.

13. The catalyst of any one of embodiments 7 to 11, wherein the NA coating (ii) comprises strontium and manganese.

14. The catalyst of any one of embodiments 11 to 13, wherein the NA coating (ii) further comprises an alkali metal, wherein the alkali metal is preferably selected from the group consisting of sodium, potassium and lithium, wherein the alkali metal is preferably sodium.

15. The catalyst of embodiment 14, wherein the NA coating (ii) comprises the alkali metal in an amount, calculated as the oxide, in the range of from 0.1 to 4 weight-%, more preferably in the range of from 0.25 to 3 weight-%, more preferably in the range of from 0.5 to 2 weight-%, based on the weight of the zeolitic material comprised in the NA coating (ii); wherein the NA coating (ii) preferably comprises sodium in an amount, calculated as NaO, in the range of from 0.1 to 4 weight-%, more preferably in the range of from 0.25 to 3 weight-%, more preferably in the range of from 0.5 to 2 weight-%, more preferably in the range of from 0.5 to 1 weight-%, based on the weight of the zeolitic material comprised in the NA coating (ii) or
wherein the NA coating (ii) preferably comprises potassium in an amount, calculated as K₂O, in the range of from 0.1 to 4 weight-%, more preferably in the range of from 0.25 to 3 weight-%, more preferably in the range of from 0.5 to 2 weight-%, more preferably in the range of from 1.2 to 2 weight-%, based on the weight of the zeolitic material comprised in the NA coating (ii).

16. The catalyst of any one of embodiments 1 to 10, wherein the NA coating (ii) further comprises one or more of Nd, La, Ce, Pr, Sm, Y and Yb, preferably one or more of Nd and Pr, more preferably Nd,
wherein the NA coating (ii) preferably comprises the one or more of Nd, La, Ce, Pr, Sm, Y and Yb, in an amount, calculated as the oxide, in the range of from 2 to 6 weight-%, more preferably in the range of from 3 to 5 weight-%, more preferably in the range of from 4 to 5 weight-% based on the weight of the zeolitic material comprised in the NA coating (ii).

17. The catalyst of any one of embodiments 1 to 10, wherein from 99 to 100 weight-%, preferably from 99.5 to 100 weight-%, more preferably from 99.9 to 100 weight-%, of the NA coating (ii) consists of the platinum group metal, preferably palladium, the zeolitic material, preferably having a framework type FER, barium, and preferably a non-zeolitic oxidic material as defined in embodiment 9 or 10.

18. The catalyst of any one of embodiments 1 to 10, wherein from 99 to 100 weight-%, preferably from 99.5 to 100 weight-%, more preferably from 99.9 to 100 weight-%, of the NA coating (ii) consists of the platinum group metal, preferably palladium, the zeolitic material, preferably having a framework type FER, strontium and preferably a non-zeolitic oxidic material as defined in embodiment 9 or 10.

19. The catalyst of any one of embodiments 1 to 13, wherein from 99 to 100 weight-%, preferably from 99.5 to 100 weight-%, more preferably from 99.9 to 100 weight-%, of the NA coating (ii) consists of the platinum group metal, preferably palladium, the zeolitic material, preferably having a framework type FER, manganese, an alkaline earth metal, preferably barium or strontium, and preferably a non-zeolitic oxidic material as defined in embodiment 9 or 10; or
wherein from 99 to 100 weight-%, preferably from 99.5 to 100 weight-%, more preferably from 99.9 to 100 weight-%, of the NA coating (ii) consists of the platinum group metal, preferably palladium, the zeolitic material, preferably having a framework type FER, manganese, barium, strontium, and preferably a non-zeolitic oxidic material as defined in embodiment 9 or 10.

20. The catalyst of any one of embodiments 1 to 11, wherein from 99 to 100 weight-%, preferably from 99.5 to 100 weight-%, more preferably from 99.9 to 100 weight-%, of the NA coating (ii) consists of the platinum group metal, preferably palladium, the zeolitic material, preferably having a framework type FER, manganese, an alkali metal, preferably sodium, as defined in embodiment 14 or 15, and preferably a non-zeolitic oxidic material as defined in embodiment 9 or 10.

21. The catalyst of any one of embodiments 1 to 8 and 13, wherein from 99 to 100 weight-%, preferably from 99.5 to 100 weight-%, more preferably from 99.9 to 100 weight-%, of the NA coating (ii) consists of the platinum group metal, preferably palladium, the zeolitic material, preferably having a framework type FER, an alkaline earth metal, preferably barium or strontium, and one or more of Nd, La, Ce, Pr, Sm, Y and Yb, and preferably a non-zeolitic oxidic material as defined in embodiment 9 or 10; or
wherein from 99 to 100 weight-%, preferably from 99.5 to 100 weight-%, more preferably from 99.9 to 100 weight-%, of the NA coating (ii) consists of the platinum group metal, preferably palladium, the zeolitic material, preferably having a framework type FER, barium, strontium, and one or more of Nd, La, Ce, Pr, Sm, Y and Yb, and preferably a non-zeolitic oxidic material as defined in embodiment 9 or 10.

22. The catalyst of any one of embodiments 1 to 11, wherein from 99 to 100 weight-%, preferably from 99.5 to 100 weight-%, more preferably from 99.9 to 100 weight-%, of the NA coating (ii) consists of the platinum group metal, preferably palladium, the zeolitic material, preferably having a framework type FER, manganese, and preferably a non-zeolitic oxidic material as defined in embodiment 9 or 10.

23. The catalyst of any one of embodiments 1 to 22, wherein the platinum group metal comprised in the DOC coating (iii) is selected from the group consisting of palladium, platinum, rhodium, iridium, osmium, ruthenium and a mixture of two or more thereof, preferably selected from the group consisting of palladium, platinum and rhodium, more preferably selected from the group consisting of palladium and platinum, more preferably is platinum.

24. The catalyst of any one of embodiments 1 to 23, wherein the DOC coating (iii) comprises the platinum group metal component at a loading, calculated as elemental platinum group metal, in the range of from 1 to 150 g/ft³, preferably in the range of from 10 to 100 g/ft³, more preferably in the range of from 20 to 90 g/ft³, more preferably in the range of from 30 to 80 g/ft³, more preferably in the range of from 40 to 80 g/ft³.

25. The catalyst of any one of embodiments 1 to 24, wherein the non-zeolitic oxidic material comprised in the DOC coating (iii) comprises one or more of alumina, silica, zirconia and titania, preferably one or more of alumina, silica and zirconia, more preferably alumina.

26. The catalyst of embodiment 25, wherein from 70 to 99 weight-%, preferably from 80 to 98 weight-%, more preferably from 90 to 97 weight-%, more preferably from 92 to 97 weight-%, of the non-zeolitic oxidic material comprised in the DOC coating (iii) consists of alumina, and
preferably wherein from 1 to 30 weight-%, more preferably from 2 to 20 weight-%, more preferably from 3 to 10 weight-%, more preferably from 3 to 8 weight-%, of the non-zeolitic oxidic material comprised in the DOC coating (iii) consists of silicon, calculated as SiO₂.

27. The catalyst of embodiment 26, wherein from 70 to 99 weight-%, preferably from 80 to 98 weight-%, more preferably from 90 to 97 weight-%, more preferably from 92 to 97 weight-%, of the non-zeolitic oxidic material comprised in the DOC coating (iii) consists of alumina, and
preferably wherein from 1 to 30 weight-%, more preferably from 2 to 20 weight-%, more preferably from 3 to 10 weight-%, more preferably from 3 to 8 weight-%, of the non-zeolitic oxidic material comprised in the DOC coating (iii) consists of manganese, calculated as MnO₂.

28. The catalyst of any one of embodiments 1 to 27, wherein the DOC coating (iii) further comprises a zeolitic material comprising one or more of iron and copper, preferably a zeolitic material comprising iron;
wherein the DOC coating (iii) comprises iron in an amount, calculated as Fe₂O₃, in the range of from 1 to 10 weight-%, more preferably in the range of from 2 to 8 weight-%, more preferably in the range of from 3 to 5 weight-%, based on the weight of the zeolitic material comprising iron comprised in the DOC coating (iii).

29. The catalyst of embodiment 28, wherein the zeolitic material comprised in the DOC coating (iii) is a 12-membered ring pore zeolitic material, wherein said zeolitic material preferably has a framework type selected from the group consisting of BEA, MOR, FAU, GME, OFF a mixture of two or more thereof and a mixed type of two or more thereof, more preferably selected from the group consisting of BEA, MOR, FAU, a mixture of two or more thereof and a mixed type of two or more thereof, more preferably selected from the group consisting of BEA and FAU, wherein more preferably the 12-membered ring pore zeolitic material comprised in the DOC coating (iii) has a framework type BEA.

30. The catalyst of embodiment 29, wherein from 95 to 100 weight-%, preferably from 98 to 100 weight-%, more preferably from 99 to 100 weight-%, more preferably from 99.5 to 100 weight-%, of the framework structure of the 12-membered ring pore zeolitic material comprised in the DOC coating (iii) consist of Si, Al, and O, wherein in the framework structure, the molar ratio of Si to Al, calculated as molar SiO₂:Al₂O₃, is more preferably in the range of from 2:1 to 60:1, more preferably in the range of from 2:1 to 50:1, more preferably in the range of from 5:1 to 40:1, more preferably in the range of from 10:1 to 35:1, more preferably in the range of from 15:1 to 30:1, more preferably in the range of from 20:1 to 27:1.

31. The catalyst of any one of embodiments 1 to 30, wherein the NA coating disposed on the surface of the internal walls of the substrate (i) extends over x % of the substrate axial length, preferably from the outlet end towards the inlet end, with x being in the range of from 40 to 100.

32. The catalyst of any one of embodiments 1 to 31, wherein the DOC coating extends over y % of the substrate axial length from the inlet end towards the outlet end, with y being in the range of from 20 to 100.

33. The catalyst of embodiment 32, as far as it depends on embodiment 34, wherein x is in the range of from 98 to 100, preferably in the range of from 99 to 100.

34. The catalyst of embodiment 32 or 33, as far as it depends on embodiment 34, wherein y is in the range of from 98 to 100, preferably in the range of from 99 to 100.

35. The catalyst of any one of embodiments 1 to 34, wherein the DOC coating (iii) has a single coat.

36. The catalyst of embodiment 35, wherein the weight ratio of the non-zeolitic oxidic material comprised in the DOC coating (iii) relative to the zeolitic material comprised in the DOC coating (iii) is in the range of from 1.5:1 to 10:1, preferably in the range of from 2:1 to 8:1, more preferably in the range of from 2.5:1 to 6:1, more preferably in the range of from 3:1 to 5:1.

37. The catalyst of embodiment 35 or 36, wherein the DOC coating (iii) comprises the non-zeolitic oxidic material in an amount in the range of from 0.75 to 3 g/in³, preferably in the range of from 1 to 2 g/in³.

38. The catalyst of any one of embodiments 1 to 34, wherein the DOC coating (iii) comprises, preferably consists of,
(iii.1) an inlet coat comprising the platinum group metal, preferably platinum, the non-zeolitic oxidic material and a zeolitic material as defined in any one of embodiments 28 to 30; and
(iii.2) an outlet coat comprising the platinum group metal, preferably platinum, and the non-zeolitic oxidic material;
wherein the inlet coat (iii.1) extends over y1% of the substrate axial length from the inlet end towards the outlet end of the substrate according to (i), wherein y1 is in the range of from 20 to 80, preferably in the range of from 30 to 60, more preferably in the range of from 45 to 55, and
wherein the outlet coat (iii.2) extends over y2% of the substrate axial length from the outlet end towards the inlet end of the substrate according to (i), wherein y2 is in the range of from 20 to 80, preferably in the range of from 30 to 60, more preferably in the range of from 45 to 55.

39. The catalyst of embodiment 38, as far as it depends on embodiment 35 or 37, wherein the inlet coat (iii.1) is disposed on the NA coating, and wherein the outlet coat (iii.2) is disposed on the NA coating, wherein y2 is y−y1.

40. The catalyst of embodiment 38 or 39, wherein the inlet coat (iii.1) comprises, in addition to platinum, palladium, wherein the weight ratio of Pt to Pd, calculated as elemental Pt and Pd, respectively, preferably is in the range of from 1:1 to 10:1, more preferably in the range of from 1.1:1 to 8:1, more preferably in the range of from 1.5:1 to 4:1.

41. The catalyst of embodiment 40, wherein the inlet coat (iii.1) comprises platinum at a Pt loading, calculated as elemental Pt, and palladium at a Pd loading, calculated as elemental Pd, wherein the sum of the Pt loading and the Pd loading is in the range of from 5 to 40 g/ft³, preferably in the range of from 10 to 30 g/ft³.

42. The catalyst of any one of embodiments 38 to 41, wherein the weight ratio of the non-zeolitic oxidic material comprised in the inlet coat (iii.1) relative to the zeolitic material comprised in the inlet coat (iii.1) is in the range of from 0.25:1 to 4:1, preferably in the range of from 0.5:1 to 2:1, more preferably in the range of from 0.75:1 to 1.5:1.

43. The catalyst of any one of embodiments 38 to 42, wherein the outlet coat (iii.2) comprises platinum at a loading, calculated as elemental Pt, in the range of from 50 to 100 g/ft³, preferably in the range of from 70 to 90 g/ft³.

44. The catalyst of embodiment 32, as far as it depends on embodiment 31, wherein x is in the range of from 40 to 60, preferably in the range of from 45 to 55.

45. The catalyst of embodiment 32 or 44, as far as it depends on embodiment 31, wherein y is in the range of from 30 to 60, more preferably in the range of from 45 to 55, more preferably y=100−x.

46. The catalyst of embodiment 32, as far as it depends on embodiment 31, wherein x is in the range of from 98 to 100, preferably in the range of from 99 to 100 and wherein y is in the range of from 20 to 40, preferably in the range of from 25 to 35.

47. The catalyst of embodiment 32, as far as it depends on embodiment 31, wherein x is in the range of from 40 to 90, preferably in the range of from 45 to 80.

48. The catalyst of embodiment 32 or 47, as far as it depends on embodiment 34, wherein y is in the range of from 50 to 100.

49. The catalyst of any one of embodiments 1 to 32 and 35 to 37, wherein the DOC coating extends over y % of the substrate axial length from the outlet end towards the inlet end, with y being in the range of from 20 to 60, preferably in the range of from 20 to 40; wherein preferably x is in the range of from 98 to 100, preferably in the range of from 99 to 100 and y is in the range of from 20 to 60, preferably in the range of from 20 to 40.

50. The catalyst of any one of embodiments 1 to 49, wherein the substrate (i) is a flow-through substrate or a wall-flow filter substrate, preferably a flow-through substrate.

51. The catalyst of embodiment 50, wherein the flow-through substrate (i) comprises, preferably consists of, a ceramic substance, wherein the ceramic substance preferably comprises, more preferably consists of, one or more of an alumina, a silica, a silicate, an aluminosilicate, preferably a cordierite or a mullite, an aluminotitanate, a silicon carbide, a zirconia, a magnesia, preferably a spinel, and a titania, more preferably one or more of a silicon carbide and a cordierite, more preferably a cordierite; or
wherein the flow-through substrate (i) comprises, preferably consists of, a metallic substance, wherein the metallic substance preferably comprises, more preferably consists of, oxygen and one or more of iron, chromium and aluminum;
wherein the substrate is preferably electrically heated.

52. The catalyst of any one of embodiments 1 to 51, consisting of the substrate (i) the NA coating (ii) and the DOC coating (iii).

53. Process for preparing a NOx adsorber diesel oxidation catalyst (NA-DOC), preferably according to any one of embodiments 1 to 52, comprising
(a) preparing a first mixture comprising water, a source of a platinum group metal, a zeolitic material and a source of one or more of an alkaline earth metal and manganese;
(b) disposing the first mixture obtained according to (a) on the surface of the internal walls of a substrate comprising an inlet end, an outlet end, a substrate axial length extending from the inlet end to the outlet end and a plurality of passages defined by internal walls of the substrate extending therethrough; calcining, obtaining a substrate having a NA coating thereon;
(c) preparing a second mixture comprising water, a source of a platinum group metal and a non-zeolitic oxidic material;
(d) disposing the second mixture obtained according to (c) on the substrate having a NA coating thereon;
(e) calcining the substrate obtained according to (d), obtaining a substrate having a NA coating and a DOC coating thereon.

54. The process of embodiment 53, wherein (a) comprises
(a.1) admixing, preferably impregnating, the zeolitic material, preferably in its ammonium form, with the source of a platinum group metal, preferably a source of palladium, more preferably palladium nitrate, and the source of one or more of an alkaline earth metal and manganese;
(a.2) dispersing the admixed zeolitic material in water;
(a.3) preferably adding a precursor of a non-zeolitic oxidic material, more preferably a precursor of zirconium, more preferably zirconium acetate.

55. The process of embodiment 53 or 54, wherein the source of the one or more of an alkaline earth metal and manganese is one or more of a nitrate, an acetate and an hydroxide, wherein preferably the source of the one or more of an alkaline earth metal and manganese are selected from the group consisting of strontium acetate, strontium nitrate, barium hydroxide, barium nitrate, manganese nitrate, manganese acetate, and a mixture of two or more thereof, more preferably selected from the group consisting of strontium acetate, barium hydroxide, barium nitrate, manganese nitrate and a mixture of two or more thereof.

56. The process of any one of embodiments 53 to 55, wherein disposing the first mixture in (b) comprises disposing the first mixture obtained in (a) from the outlet end towards to the inlet end of the substrate over x % of the substrate axial length, wherein x is in the range of from 98 to 100, preferably in the range of from 99 to 100; or wherein x is in the range of from 40 to 90, preferably in the range of from 45 to 80.

57. The process of any one of embodiments 53 to 56, wherein calcining according to (b) is performed in a gas atmosphere having a temperature in the range of from 400 to 800° C., preferably in the range of from 450 to 700° C., more preferably in the range of from 550 to 650° C., the gas atmosphere more preferably comprising one or more of oxygen and nitrogen, more preferably air.

58. The process of any one of embodiments 53 to 57, wherein calcining according to (b) is performed in a gas atmosphere for a duration in the range of from 0.5 to 5 hours, preferably in the range of from 1.5 to 2.5 hours, the gas atmosphere more preferably comprising one or more of oxygen and nitrogen, more preferably air.

59. The process of any one of embodiments 53 to 58, wherein, prior to calcining according to (b), drying of the coated substrate is performed in a gas atmosphere having a temperature in the range of from 90 to 150° C., preferably in the range of from 100 to 120° C., the gas atmosphere more preferably being air.

60. The process of any one of embodiments 53 to 59, wherein, prior to calcining according to (b), drying of the coated substrate is performed in a gas atmosphere for a duration in the range of from 0.5 to 4 hours, preferably in the range of from 0.75 to 2 hours, the gas atmosphere more preferably comprising one or more of oxygen and nitrogen, more preferably air.

61. The process of any one of embodiments 53 to 60, wherein (c) comprises
(c.1) admixing, preferably impregnating, a non-zeolitic oxidic material, preferably as defined in any one of embodiments 25 to 27, with a source of a platinum group metal;
(c.2) dispersing the admixed, preferably impregnated, non-zeolitic oxidic material in water.

62. The process of embodiment 61, wherein (c) further comprises
(c.3) admixing a zeolitic material comprising one or more of iron and copper, preferably a zeolitic material comprising iron, to the dispersion obtained according to (c.2), obtaining the second mixture, wherein the zeolitic material preferably is as defined in embodiment 29 or 30.

63. The process of any one of embodiments 53 to 62, wherein disposing the second mixture in (d) comprises disposing the second mixture obtained in (c) from the inlet end towards to the outlet end of the substrate over y % of the substrate axial length, wherein y is in the range of from 98 to 100, preferably in the range of from 99 to 100 or wherein y is in the range of from 30 to 60, more preferably in the range of from 45 to 55, more preferably y=100−x.

64. The process of any one of embodiments 53 to 63, wherein disposing the second mixture in (d) comprises disposing the second mixture obtained in (c) from the inlet end towards to the outlet end of the substrate over y1% of the substrate axial length, wherein y1 is in the range of from 20 to 80, preferably from 30 to 60, more preferably from 45 to 55.

65. The process of embodiment 64, wherein (d) further comprising, prior to calcining according to (e),
preparing a third mixture comprising water and a source of a platinum group metal and a non-zeolitic oxidic material;
disposing the third mixture on the substrate from the outlet end towards to the inlet end of the substrate over y2% of the substrate axial length, wherein y2 is in the range of from 20 to 80, preferably from 30 to 60, more preferably from 45 to 55, more preferably y2 is 100−y1, and optionally drying.

66. The process of any one of embodiments 53 to 65, wherein calcining according to (e) is performed in a gas atmosphere having a temperature in the range of from 400 to 800° C., preferably in the range of from 450 to 700° C., more preferably in the range of from 550 to 650° C., the gas atmosphere more preferably comprising one or more of oxygen and nitrogen, more preferably air.

67. The process of any one of embodiments 53 to 66, wherein calcining according to (e) is performed in a gas atmosphere for a duration in the range of from 0.5 to 5 hours, preferably in the range of from 1.5 to 2.5 hours, the gas atmosphere more preferably comprising one or more of oxygen and nitrogen, more preferably air.

68. The process of any one of embodiments 53 to 67, wherein, prior to calcining according to (e), drying of the coated substrate is performed in a gas atmosphere having a temperature in the range of from 90 to 150° C., preferably in the range of from 100 to 120° C., the gas atmosphere more preferably being air.

69. The process of any one of embodiments 53 to 68, wherein prior to calcining according to (e), drying of the coated substrate is performed in a gas atmosphere for a duration in the range of from 0.5 to 4 hours, preferably in the range of from 0.75 to 2 hours, the gas atmosphere more preferably comprising one or more of oxygen and nitrogen, more preferably air.

70. The process of any one of embodiments 53 to 69 consisting of (a), (b), (c), (d) and (e).

71. A NOx adsorber diesel oxidation catalyst (NA-DOC) obtained or obtainable by a process according to any one of embodiments 53 to 70.

72. Use of a NOx adsorber diesel oxidation catalyst (NA-DOC) according to any one of embodiments 1 to 52 and 71 for the NOx adsorption/desorption and the conversion of HC and CO.

73. An exhaust treatment system for the treatment of an exhaust gas, the system comprising a NOx adsorber diesel oxidation (NA-DOC) catalyst according to any one of embodiments 1 to 52 and 71;
the system preferably further comprises one or more of a selective catalytic reduction catalyst (SCR), a selective catalytic reduction catalyst on a filter (SCRoF) and an ammonia oxidation (AMOX) catalyst,
wherein the NA-DOC catalyst is preferably located upstream of the one or more of a selective catalytic reduction catalyst (SCR), a selective catalytic reduction catalyst on a filter (SCRoF) and an ammonia oxidation (AMOX) catalyst.

74. The system of embodiment 73, wherein the system further comprises a selective catalytic reduction catalyst (SCR) and an ammonia oxidation (AMOX) catalyst, wherein the NA-DOC catalyst is located upstream of the selective catalytic reduction catalyst (SCR) and the SCR catalyst is located upstream of the ammonia oxidation (AMOX) catalyst, wherein preferably no catalyst for treating the exhaust gas stream exiting the NA-DOC catalyst and upstream of the SCR catalyst is located in the exhaust gas treatment system.

75. The system of embodiment 73, wherein the system further comprises a selective catalytic reduction catalyst on a filter (SCRoF) and an ammonia oxidation (AMOX) catalyst, wherein the NA-DOC catalyst is located upstream of the selective catalytic reduction catalyst on a filter (SCRoF) and the SCRoF catalyst is located upstream of the ammonia oxidation (AMOX) catalyst, wherein preferably no catalyst for treating the exhaust gas stream exiting the NA-DOC catalyst and upstream of the SCRoF catalyst is located in the exhaust gas treatment system.

76. The system of embodiment 73, wherein the system further comprises a selective catalytic reduction catalyst on a filter (SCRoF), a selective catalytic reduction catalyst (SCR) and an ammonia oxidation (AMOX) catalyst, wherein the NA-DOC catalyst is located upstream of the selective catalytic reduction catalyst on a filter (SCRoF), the SCRoF catalyst is located upstream of the SCR catalyst, and the SCR catalyst is located upstream of the AMOX catalyst, wherein preferably no catalyst for treating the exhaust gas stream exiting the NA-DOC catalyst and upstream of the SCRoF catalyst is located in the exhaust gas treatment system.

77. The system of embodiment 73, wherein the system further comprises a first electrically heated substrate, wherein the NA-DOC catalyst is located downstream of said first electrically heated substrate.

78. The system of embodiment 77, wherein the system further comprises a second electrically heated substrate, wherein the NA-DOC catalyst is located downstream of said second electrically heated substrate.

79. A method for the treatment of an exhaust gas comprising providing an exhaust gas, preferably from an internal combustion engine, more preferably from a diesel engine;
contacting the exhaust gas with a NOx adsorber diesel oxidation catalyst according to any one of embodiments 1 to 52 and 71.

In the context of the present invention, the term “loading of a given component/coating” (in g/in³ or g/ft³) refers to the mass of said component/coating per volume of the substrate, wherein the volume of the substrate is the volume which is defined by the cross-section of the substrate times the axial length of the substrate over which said component/coating is present. For example, if reference is made to the loading of a coating extending over x % of the axial length of the substrate and having a loading of X g/in³, said loading would refer to X gram of the coating per x % of the volume (in in³) of the entire substrate.

Further, in the context of the present invention, the term “the surface of the internal walls” is to be understood as the “naked” or “bare” or “blank” surface of the walls, i.e. the surface of the walls in an untreated state which consists—apart from any unavoidable impurities with which the surface may be contaminated—of the material of the walls.

Furthermore, in the context of the present invention, a term “X is one or more of A, B and C”, wherein X is a given feature and each of A, B and C stands for specific realization of said feature, is to be understood as disclosing that X is either A, or B, or C, or A and B, or A and C, or B and C, or A and B and C. In this regard, it is noted that the skilled person is capable of transfer to above abstract term to a concrete example, e.g. where X is a chemical element and A, B and C are concrete elements such as Li, Na, and K, or X is a temperature and A, B and C are concrete temperatures such as 10° C., 20° C., and 30° C. In this regard, it is further noted that the skilled person is capable of extending the above term to less specific realizations of said feature, e.g. “X is one or more of A and B” disclosing that X is either A, or B, or A and B, or to more specific realizations of said feature, e.g. “X is one or more of A, B, C and D”, disclosing that X is either A, or B, or C, or D, or A and B, or A and C, or A and D, or B and C, or B and D, or C and D, or A and B and C, or A and B and D, or B and C and D, or A and B and C and D.

In the context of the present invention, the alkaline earth metal in the NA coating is preferably present as oxide, cation and/or carbonate.

The present invention is further illustrated by the following Examples.

### EXAMPLES

### Reference Example 1

### 1.1 Determination of the Particle Size Distribution, Dv10, Dv50, Dv90 Values

The particle size distributions were determined by a static light scattering method using Sympatec HELOS equipment, wherein the optical concentration of the sample was in the range of from 5 to 10%.

### 1.2 Measurement of the BET Specific Surface Area

The BET specific surface area was determined according to DIN 66131 or DIN ISO 9277 using liquid nitrogen.

### 1.3 Determination of the Crystallinity

The determination of the relative crystallinity of a zeolite was performed via x-ray diffraction using a test method under the jurisdiction of ASTM Committee D32 on catalysts, in particular of Subcommittee D32.05 on zeolites. The current edition was approved on Mar. 10, 2001 and published in May 2001, which was originally published as D 5758-95.

### 1.4 Determination of the Total Pore Volume

The total pore volume was determined according to ISO 15901-2:2006.

### Comparative Example 1: Preparation of a NOx Adsorber Diesel Oxidation Catalyst—FER

### Bottom Coating (NA Coating):

An ammonium ferrierite zeolitic material (a zeolitic material having framework structure type FER, a SiO₂:Al₂O₃ molar ratio of 21:1 and a crystallinity vs. standard (XRD) >80%) was wet impregnated with an aqueous palladium nitrate solution to attain a Pd loading of 0.8 weight-% based on the weight of the final material (zeolitic material+palladium). To the resulting slurry a zirconium acetate mixture was added. The amount of zirconium acetate was calculated such that the amount of zirconia in the bottom coating, calculated as ZrO₂, was 5 weight-% based on the weight of the zeolitic material.

A porous uncoated flow-through honeycomb substrate, cordierite (total volume 0.04 L, 400 cpsi and 4 mil wall thickness, diameter: 1 inch x length: 3 inches), was coated with the obtained slurry over 100% of the substrate axial length. The coated substrate was dried in air at 110° C. for 1 h and subsequently calcined in air at 590° C. for 2 h, forming a bottom coating. The concentration of palladium in the bottom coating was 20 g/ft³ and the concentration of the FER in bottom coating loading was 1.5 g/in³. The loading of the bottom coating was 1.51 g/in³.

### Top Coating (DOC Coating):

An alumina support material comprising 5% by weight SiO₂ was impregnated with platinum via a wet impregnation process. A Fe-Beta zeolitic material (a zeolitic material having framework structure type BEA, a SiO₂:Al₂O₃ molar ratio of 23:1 and a crystallinity vs. standard (XRD) >90% and Fe content, calculated as Fe₂O₃: 4.3 weight-% based on the weight of the zeolitic material) was added to the Pt-alumina slurry. The weight ratio of the alumina doped with Si to the Beta zeolitic material was of 4.2/1. A slurry containing this material and Beta zeolite was coated over 100% of the cordierite substrate containing already the Pd/FER bottom layer. The coated substrate was dried in air at 120° C. for 60 min and calcined in air at 590° C. ° C. for 2 hours. The top layer contained 60 g/ft³ platinum. The loading of the top coating was 1.9 g/in³.

### Examples 1 to 3: Preparation of a NOx-Adsorber Diesel Oxidation Catalyst—FER with Ba Additive

### Bottom Coating (NA Coating):

An ammonium ferrierite zeolitic material (a zeolitic material having framework structure type FER, a SiO₂:Al₂O₃ molar ratio of 21:1 and a crystallinity vs. standard (XRD) >80%) was wet impregnated with an aqueous palladium nitrate solution and barium hydroxide to attain a Pd loading of 0.77 weight-% based on the weight of the final material (zeolitic material+palladium) and the following weight-% based Ba loadings:

| | Ba content, calculated as |
|---|---|
| Sample | BaO, in weight-% |
| (bottom coating) | based on the FER amount |
| Example 1 | 1.7 |
| Example 2 | 3.4 |
| Example 3 | 6.8 |

To the resulting slurry a zirconium acetate mixture was added. The amount of zirconium acetate was calculated such that the amount of zirconia in the bottom coating, calculated as ZrO₂, was 5 weight-% based on the weight of the zeolitic material.

A porous uncoated flow-through honeycomb substrate, cordierite (total volume 0.04 L, 400 cpsi and 4 mil wall thickness, core with diameter: 1 inch x length: 3 inches), was coated with the obtained slurry over 100% of the substrate axial length. The coated substrate was dried in air having a temperature of 110° C. for 1 h and subsequently calcined in air at 590° C. for 2 h, forming a bottom coating. The concentration of palladium in the bottom coating was 20 g/ft³ and the concentration of the FER in bottom coating loading was 1.5 g/in³. The loading of the bottom coating was 1.61 g/in³ (Ex. 1), 1.64 g/in³ (Ex. 2) and 1.69 g/in³ (Ex. 3).

### Top Coating (DOC Coating):

The slurries for preparing the top coating of Examples 1-3 were prepared as the slurry for preparing the top coating of Comparative Example 1. The slurry for each of Examples 1-3 was coated over 100% of the cordierite substrate containing already the Ba/Pd/FER bottom coating. The top coating contained 60 g/ft³ platinum. The loading of the top coating was 1.9 g/in³.

### Examples 4 to 6: Preparation of a NOx-Adsorber Diesel Oxidation Catalyst—FER with Sr Additive

### Bottom Coating (NA Coating):

An ammonium ferrierite zeolitic material (a zeolitic material having framework structure type FER, a SiO₂:Al₂O₃ molar ratio of 21:1 and a crystallinity vs. standard (XRD) >80%) was wet impregnated with an aqueous palladium nitrate solution and strontium acetate to attain a Pd loading of 0.77 weight-% based on the weight of the final material (zeolitic material+palladium) an the following Sr content:

| | Sr content, calculated as |
|---|---|
| Sample | SrO, in weight.% |
| (bottom coating) | based on the FER amount |
| Example 4 | 1.7 |
| Example 5 | 3.4 |
| Example 6 | 6.8 |

To the resulting slurry a zirconium acetate mixture was added. The amount of zirconium acetate was calculated such that the amount of zirconia in the bottom coating, calculated as ZrO₂, was 5 weight-% based on the weight of the zeolitic material.

A porous uncoated flow-through honeycomb substrate, cordierite (total volume 0.04 L, 400 cpsi and 4 mil wall thickness, diameter: 1 inch x length: 3 inches), was coated with the obtained slurry over 100% of the substrate axial length. The coated substrate was dried in air having a temperature of 110° C. for 1 h and subsequently calcined in air at 590° C. for 2 h, forming a bottom coating. The concentration of palladium in the bottom coating was 20 g/ft³ and the concentration of the FER in bottom coating loading was 1.5 g/in³. The loading of the bottom coating was 1.61 g/in³ (Ex. 4), 1.64 g/in³ (Ex. 5) and 1.69 g/in³ (Ex. 6).

### Top Coating (DOC Coating):

The slurries for preparing the top coating of Examples 4-6 were prepared as the slurry for preparing the top coating of Comparative Example 1. The slurry for each of Examples 1-3 was coated over 100% of the cordierite substrate containing already the Sr/Pd/FER bottom coating. The top coating contained 60 g/ft³ platinum. The loading of the top coating was 1.9 g/in³.

TABLE 1

| | Bottom coating | Top coating |
|---|---|---|
| Sample | (substrate axial length) | (substrate axial length) |
| Comp. | 20 g/ft³ Pd-FER (100%) | 60 g/ft³ Pt Alumina + |
| Example 1 | | Fe-Beta (100%) |
| Example 1 | 20 g/ft³ Pd-FER + | 60 g/ft³ Pt Alumina + |
| | 1.7 wt.-% BaO (100%) | Fe-Beta (100%) |
| Example 2 | 20 g/ft³ Pd-FER + | 60 g/ft³ Pt Alumina + |
| | 3.4 wt.-% BaO (100%) | Fe-Beta (100%) |
| Example 3 | 20 g/ft³ Pd-FER + | 60 g/ft³ Pt Alumina + |
| | 6.8 wt.-% BaO (100%) | Fe-Beta (100%) |
| Example 4 | 20 g/ft³ Pd-FER + | 60 g/ft³ Pt Alumina + |
| | 1.7 wt.-% SrO (100%) | Fe-Beta (100%) |
| Example 5 | 20 g/ft³ Pd-FER + | 60 g/ft³ Pt Alumina + |
| | 3.4 wt.-% SrO (100%) | Fe-Beta (100%) |
| Example 6 | 20 g/ft³ Pd-FER + | 60 g/ft³ Pt Alumina + |
| | 6.8 wt.-% SrO (100%) | Fe-Beta (100%) |

### Example 7: Evaluation of NOx-Adsorber Diesel Oxidation Catalyst of Comparative Example 1 and of Examples 2 to 6 on a Lab Reactor

The catalysts of Examples 2 to 6 and of Comparative Example 1 were tested for NOx adsorption and desorption performance after hydrothermal aging at 800° C. for 16 hours in 10% steam (water)/air. Prior to desorption, the cores were exposed to a mixture of 200 ppm nitric oxide (NO), 500 ppm carbon monoxide (CO), 500 ppm propylene (C₃H₆, C₁ basis), 7% oxygen (O₂), 5% carbon dioxide (CO₂), 5% water (H₂O) and balance nitrogen (N₂) for 15 minutes at 100° C. During this period, NO was adsorbed to the Pd/FER. After the adsorption phase, the NO, CO and propylene were turned off and the temperature of the sample was raised to 500° C. at 60K/min. During this period, NO that was adsorbed to the Pd/FER was desorbed (desorption phase). The temperature of the NOx adsorption and the amount of desorbed NOx was evaluated. NO desorption curves for the Comparative Example 1 and Examples 2-6 as a function of temperature are shown in FIG. 1. The amount of desorbed NOx is shown in Table 1.

TABLE 2
Amount of desorbed NOx for
Comparative Example 1 and Examples 2-6

| Sample | Desorbed amount of NOx/g/l |
|---|---|
| Comp. Example 1 | 0.20 |
| Example 1 | 0.21 |
| Example 2 | 0.20 |
| Example 3 | 0.18 |
| Example 4 | 0.18 |
| Example 5 | 0.17 |
| Example 6 | 0.16 |

As may be taken from FIG. 1, namely the NOx desorption curves of the tested samples, it can be concluded that the additive Sr and Ba permit the desired increase of the NOx desorption temperature. Indeed, such additives permit to reduce the first peak desorption temperature (about 200° C.) and increase the second peak desorption temperature (about 300° C.). The higher the amount of the additive the higher the increase of the NOx desorption. It is noted that the increase of the additive can also result in a slight decrease in the adsorption capacity which can be seen in Table 1 but in any case the adsorption capacity obtained by the catalysts according to the present invention are good. The amount of desorbed NOx relates to the previously adsorbed NOx at 100° C.

### Comparative Example 2: Preparation of High Pd Containing a NOx Adsorber Diesel Oxidation Catalyst—FER

### Bottom Coating (NA Coating):

An ammonium ferrierite zeolitic material (a zeolitic material having framework structure type FER, a SiO₂:Al₂O₃ molar ratio of 21:1 and a crystallinity vs. standard (XRD) >80%) was wet impregnated with an aqueous palladium nitrate solution to attain a Pd loading of 1.48 weight-% based on the weight of the final material (zeolitic material+palladium). To the resulting slurry a zirconium acetate mixture was added. The amount of zirconium acetate was calculated such that the amount of zirconia in the bottom coating, calculated as ZrO₂, was 5 weight-% based on the weight of the zeolitic material.

A porous uncoated round flow-through honeycomb substrate, cordierite (total volume 1.85 L, 400 cpsi and 4 mil wall thickness, diameter: 5.66 inches×length: 4.5 inches), was coated with the obtained slurry over 100% of the substrate axial length. The coated substrate was dried in air at 110° C. for 1 h and subsequently calcined in air at 590° C. for 2 h, forming a bottom coating. The concentration of palladium in the bottom coating was 70 g/ft³, the concentration of the FER in bottom coating loading was 2.7 g/in³ and of ZrO₂ was 0.135 g/in³. The loading of the bottom coating was 2.9 g/in³.

### Top Coating (DOC Coating):

### Outlet Coat:

An Al₂O₃ support material comprising 5 weight-% MnO₂ (Al₂O₃ 95 weight-% with Mn 5 weight-%, calculated as MnO₂, having a BET specific surface area of greater than 100 m²/g, and a pore volume of greater than 0.06 cm³/g) was impregnated with platinum via a wet impregnation process. A slurry containing the resulting material was coated over 50% of the substrate axial length from the outlet end towards the inlet end of the cordierite substrate carrying the Pd-FER bottom coating. The outlet coat contained 80 g/ft³ platinum and the loading of the outlet coat was 1.3 g/in³.

### Inlet Coat:

An alumina support material comprising 5% by weight SiO₂ was impregnated with platinum and palladium in a weight ratio of 2:1 via a wet impregnation process. A Fe-Beta zeolitic material (a zeolitic material having framework structure type BEA, a SiO₂:Al₂O₃ molar ratio of 23:1 and a crystallinity vs. standard (XRD) >90% and Fe content, calculated as Fe₂O₃: 4.3 weight-% based on the weight of the zeolitic material) was added to the Pt/Pd-alumina slurry. The weight ratio of the alumina doped with Si to the Beta zeolitic material was of 1/1. A slurry containing this material and Beta zeolite was coated over 50% of the substrate axial length from the inlet end towards the outlet end of the cordierite substrate supporting already the Pd-FER bottom layer and the outlet coat. The inlet coat contained 13.3 g/ft³ platinum and 6.7 g/ft³ Pd. The loading of the inlet coat was 1.41 g/in³. The total loading of the top coating (outlet coat+inlet coat) was 1.355 g/in³.

### Example 8A: Preparation of High Pd Containing a NOx Adsorber Diesel Oxidation Catalyst—FER with Mn Additive

### Bottom Coating (NA Coating):

An ammonium ferrierite zeolitic material (a zeolitic material having framework structure type FER, a SiO₂:Al₂O₃ molar ratio of 21:1 and a crystallinity vs. standard (XRD) >80%) was wet impregnated with an aqueous palladium nitrate solution and Manganese nitrate to attain a Pd loading of 1.48 weight-% based on the weight of the zeolitic material+palladium and 1 weight-% MnO₂ loading based on the FER amount. To the resulting slurry a zirconium acetate mixture was added. The amount of zirconium acetate was calculated such that the amount of zirconia in the bottom coating, calculated as ZrO₂, was 5 weight-% based on the weight of the zeolitic material.

A porous uncoated round flow-through honeycomb substrate, cordierite (total volume 1.85 L, 400 cpsi and 4 mil wall thickness, diameter: 5.66 inches×length: 4.5 inches), was coated with the obtained slurry over 100% of its substrate axial length. The coated substrate was dried in air at 110° C. for 1 h and subsequently calcined in air at 590° C. for 2 h, forming a bottom coating. The concentration of palladium in the bottom coating was 70 g/ft³ and the concentration of the FER in bottom coating loading was 2.7 g/in³ and of ZrO₂ was 0.135 g/in³. The loading of the bottom coating was about 2.927 g/in³.

### Top Coating (DOC Coating):

The top coating of Example 8A was prepared as the top coating of Comparative Example 2 and covers the bottom coating over 100% of the substrate axial length. The total loading of the top coating was 1.355 g/in³.

### Example 8: Preparation of High Pd Containing a NOx-Adsorber Diesel Oxidation Catalyst—FER with Ba Additive

### Bottom Coating (NA Coating):

An ammonium ferrierite zeolitic material (a zeolitic material having framework structure type FER, a SiO₂:Al₂O₃ molar ratio of 21:1 and a crystallinity vs. standard (XRD) >80%) was wet impregnated with an aqueous palladium nitrate solution and barium hydroxide to attain a Pd loading of 1.48 weight-% based on the weight of the final material (zeolitic material+palladium) and 6.8 weight-% BaO loading based on the FER amount. To the resulting slurry a zirconium acetate mixture was added. The amount of zirconium acetate was calculated such that the amount of zirconia in the bottom coating, calculated as ZrO₂, was 5 weight-% based on the weight of the zeolitic material.

A porous uncoated round flow-through honeycomb substrate, cordierite (total volume 1.85 L, 400 cpsi and 4 mil wall thickness, diameter: 5.66 inches×length: 4.5 inches), was coated with the obtained slurry over 100% of its substrate axial length. The coated substrate was dried in air at 110° C. for 1 h and subsequently calcined in air at 590° C. for 2 h, forming a bottom coating. The concentration of palladium in the bottom coating was 70 g/ft³, the concentration of the FER in bottom coating loading was 2.7 g/in³ and of ZrO₂ was 0.135 g/in³. The loading of the bottom coating was about 3.084 g/in³.

### Top Coating (DOC Coating):

The top coating of Example 8 was prepared as the top coating of Comparative Example 2 and covers the aforementioned bottom coating over 100% of the substrate axial length. The total loading of the top coating was 1.355 g/in³.

### Example 9: Preparation of High Pd Containing a NOx-Adsorber Diesel Oxidation Catalyst—FER with Sr Additive

### Bottom Coating (NA Coating):

An ammonium ferrierite zeolitic material (a zeolitic material having framework structure type FER, a SiO₂:Al₂O₃ molar ratio of 21:1 and a crystallinity vs. standard (XRD) >80%) was wet impregnated with an aqueous palladium nitrate solution and strontium acetate to attain a Pd loading of 1.48 weight-% based on the weight of the final material zeolitic material+palladium) and 6.8 weight-% SrO loading based on the FER amount. To the resulting slurry a zirconium acetate mixture was added. The amount of zirconium acetate was calculated such that the amount of zirconia in the bottom coating, calculated as ZrO₂, was 5 weight-% based on the weight of the zeolitic material.

A porous uncoated round flow-through honeycomb substrate, cordierite (total volume 1.85 L, 400 cpsi and 4 mil wall thickness, diameter: 5.66 inches×length: 4.5 inches), was coated with the obtained slurry over 100% of its substrate axial length. The coated substrate was dried in air at 110° C. for 1 h and subsequently calcined in air at 590° C. for 2 h, forming a bottom coating. The concentration of palladium in the bottom coating was 70 g/ft³, the concentration of the FER in bottom coating loading was 2.7 g/in³ and of ZrO₂ was 0.135 g/in³. The loading of the bottom coating was about 2.9 g/in³.

### Top Coating DOC (Second Coating):

The top coating of Example 9 was prepared as the top coating of Comparative Example 2 and covers the aforementioned bottom coating over 100% of the substrate axial length. The total loading of the top coating was 1.355 g/in³.

### Example 10: Preparation of High Pd Containing a NOx Adsorber Diesel Oxidation Catalyst—FER with Mn and Ba Additives

### Bottom Coating (NA Coating):

An ammonium ferrierite zeolitic material (a zeolitic material having framework structure type FER, a SiO₂:Al₂O₃ molar ratio of 21:1 and a crystallinity vs. standard (XRD) >80%) was wet impregnated with an aqueous palladium nitrate solution, Barium hydroxide and Manganese nitrate to attain a Pd loading of 1.48 weight-% based on the weight of the final material (zeolitic material+palladium), 4.3 weight-% BaO and 1 weight-% MnO₂ loading based on the FER amount. To the resulting slurry a zirconium acetate mixture was added. The amount of zirconium acetate was calculated such that the amount of zirconia in the bottom coating, calculated as ZrO₂, was 5 weight-% based on the weight of the zeolitic material.

A porous uncoated round flow-through honeycomb substrate, cordierite (total volume 1.85 L, 400 cpsi and 4 mil wall thickness, diameter: 5.66 inches×length: 4.5 inches), was coated with the obtained slurry over 100% of the substrate axial length. The coated substrate was dried in air at 110° C. for 1 h and subsequently calcined in air at 590° C. for 2 h, forming a bottom coating. The concentration of palladium in the bottom coating was 70 g/ft³, the concentration of the FER in bottom coating loading was 2.7 g/in³ and of ZrO₂ was 0.135 g/in³. The loading of the bottom coating was 3.11 g/in³.

### Top Coating (DOC Coating):

The top coating of Example 8 was prepared as the top coating of Comparative Example 2 and covers the aforementioned bottom coating over 100% of the substrate axial length. The total loading of the top coating was 1.355 g/in³.

TABLE 3

| | Bottom coating | Top coating |
|---|---|---|
| Samples | (substrate axial length) | (substrate axial length) |
| Comp. | 70 g/ft³ Pd-FER (100%) | Inlet (50%): 20 g/ft³ |
| Example 2 | | Pt/Pd-Alumina + Fe-Beta |
| | | Outlet (50%): 80 g/ft³ |
| | | Pt-Alumina |
| Example 8A | 70 g/ft³ Pd-FER + | Inlet (50%): 20 g/ft³ |
| | 1% MnO₂ (100%) | Pt/Pd-Alumina + Fe-Beta |
| | | Outlet (50%): 80 g/ft³ |
| | | Pt-Alumina |
| Example 8 | 70 g/ft³ Pd-FER + | Inlet (50%): 20 g/ft³ |
| | 6.8 wt.-% BaO (100%) | Pt/Pd-Alumina + Fe-Beta |
| | | Outlet (50%): 80 g/ft³ |
| | | Pt Alumina |
| Example 9 | 20 g/ft³ Pd-FER + | Inlet (50%): 20 g/ft³ |
| | 6.8 wt.-% SrO (100%) | Pt/Pd-Alumina + Fe-Beta |
| | | Outlet (50%): 80 g/ft³ |
| | | Pt-Alumina |
| Example 10 | 70 g/ft³ Pd-FER + | Inlet (50%): 20 g/ft³ |
| | 1 wt.-% MnO₂ + | Pt/Pd-Alumina + Fe-Beta |
| | 4.3 wt.-% BaO (100%) | Outlet (50%): |
| | | 80 g/ft³ Pt-Alumina |

### Example 11: Evaluation of NOx Adsorber Diesel Oxidation Catalyst Comparative Example 2 and Examples 8A, 8 to 10 on a Lab Reactor

Cores having a diameter of 1 inch and a length of 3 inches were drilled out from the coated substrates of Comparative Example 2, Examples 8A and 8-10 to be tested on a Lab reactor. These cores were tested for NOx adsorption and desorption performance after hydrothermal aging at 800° C. for 16 hours in 10% steam (water)/air. Prior to desorption, the cores were exposed to a mixture of 200 ppm nitric oxide (NO), 500 ppm carbon monoxide (CO), 500 ppm propylene (C₃H₆, C₁ basis), 7% oxygen (O₂), 5% carbon dioxide (CO₂), 5% water (H₂O) and balance nitrogen (N₂) for 15 minutes at 100° C. During this period, NO was adsorbed to the Pd/FER. After the adsorption phase, the NO, CO and propylene were turned off and the temperature of the sample was raised to 500° C. at 20° C./min. During this period, NO that was adsorbed to the Pd/zeolite was desorbed (desorption phase). The temperature of NOx adsorption and the amount of desorbed NOx was evaluated. NO desorption curves for Comparative Example 2, Reference Example 2 and Examples 8-10 as a function of temperature are shown in FIG. 2. The amount of desorbed NOx is shown in Table 4. The amount of desorbed NOx relates to the previously adsorbed NOx at 100° C.

TABLE 4
Amount of desorbed NOx for Comparative
Example 2, Examples 8A and 8-10

| Sample | Desorbed amount of NOx/g/l |
|---|---|
| Comp. Example 2 | 0.56 |
| Example 8A | 0.61 |
| Example 8 | 0.55 |
| Example 9 | 0.34 |
| Example10 | 0.52 |

As may be taken from FIG. 2, namely the NOx desorption curves, it can be concluded that the additive Mn, Sr and Ba as well as Ba+Mn cause the desired increase of the NOx desorption temperature also with high Pd loading. The optimum NOx desorption window is achieved for the Example 10, the combination of the additives Ba and Mn. The adsorption capacity is only slightly reduced for Example 10.

### Example 12: Preparation of High Pd Containing a NOx Adsorber Diesel Oxidation Catalyst—FER with Mn and Na Additives

### Bottom Coating (NA Coating):

An ammonium ferrierite zeolitic material (a zeolitic material having framework structure type FER, a SiO₂:Al₂O₃ molar ratio of 21:1 and a crystallinity vs. standard (XRD) >80%) was wet impregnated with an aqueous palladium nitrate solution, sodium nitrate and manganese nitrate to attain a Pd loading of 1.59 weight-% based on the weight of the final material (zeolitic material+palladium), 0.7 weight-% NaO and 1 weight-% MnO₂ loading based on the FER amount. To the resulting slurry a zirconium acetate mixture was added. The amount of zirconium acetate was calculated such that the amount of zirconia in the bottom coating, calculated as ZrO₂, was 5 weight-% based on the weight of the zeolitic material.

A porous uncoated round flow-through honeycomb substrate, cordierite (total volume 0.04 L, 400 cpsi and 4 mil wall thickness, core of diameter: 1 inch x length: 3 inches), was coated with the obtained slurry over 100% of the substrate axial length. The coated substrate was dried in air at 110° C. for 1 h and subsequently calcined in air at 590° C. for 2 h, forming a bottom coating. The concentration of palladium in the bottom coating was 70 g/ft³, the concentration of the FER in bottom coating loading was 2.5 g/in³ and of ZrO₂ was 0.125 g/in³. The loading of the bottom coating was 2.71 g/in³.

### Top Coating (DOC Coating):

The top coating of Example 12 was prepared as the top coating of Example 1-3 and covers the aforementioned bottom coating over 100% of the substrate axial length, except that the platinum loading was of 50 g/ft³. The total loading of the top coating was 1.9 g/in³.

### Example 13: Preparation of High Pd Containing a NOx Adsorber Diesel Oxidation Catalyst—FER with Mn and Sr Additives

### Bottom Coating (NA Coating):

An ammonium ferrierite zeolitic material (a zeolitic material having framework structure type FER, a SiO₂:Al₂O₃ molar ratio of 21:1 and a crystallinity vs. standard (XRD) >80%) was wet impregnated with an aqueous palladium nitrate solution, strontium acetate and manganese nitrate to attain a Pd loading of 1.59 weight-% based on the weight of the final material (zeolitic material+palladium), 3 weight-% SrO and 1 weight-% MnO₂ loading based on the FER amount. To the resulting slurry a zirconium acetate mixture was added. The amount of zirconium acetate was calculated such that the amount of zirconia in the bottom coating, calculated as ZrO₂, was 5 weight-% based on the weight of the zeolitic material. A porous uncoated round flow-through honeycomb substrate, cordierite (total volume 0.04 L, 400 cpsi and 4 mil wall thickness, core of diameter: 1 inch x length: 3 inches), was coated with the obtained slurry over 100% of the substrate axial length. The coated substrate was dried in air at 110° C. for 1 h and subsequently calcined in air at 590° C. for 2 h, forming a bottom coating. The concentration of palladium in the bottom coating was 70 g/ft³, the concentration of the FER in bottom coating loading was 2.5 g/in³ and of ZrO₂ was 0.125 g/in³. The loading of the bottom coating was 2.76 g/in³.

### Top Coating (DOC Coating):

The top coating of Example 13 was prepared as the top coating of Example 12 and covers the aforementioned bottom coating over 100% of the substrate axial length. The total loading of the top coating was 1.9 g/in³.

### Example 14: Preparation of High Pd Containing a NOx Adsorber Diesel Oxidation Catalyst—FER with Mn and Ba Additives

### Bottom Coating (NA Coating):

An ammonium ferrierite zeolitic material (a zeolitic material having framework structure type FER, a SiO₂:Al₂O₃ molar ratio of 21:1 and a crystallinity vs. standard (XRD) >80%) was wet impregnated with an aqueous palladium nitrate solution, barium hydroxide and manganese nitrate to attain a Pd loading of 1.59 weight-% based on the weight of the final material (zeolitic material+palladium), 4.3 weight-% BaO and 1 weight-% MnO₂ loading based on the FER amount. To the resulting slurry a zirconium acetate mixture was added. The amount of zirconium acetate was calculated such that the amount of zirconia in the bottom coating, calculated as ZrO₂, was 20 weight-% based on the weight of the zeolitic material. A porous uncoated round flow-through honeycomb substrate, cordierite (total volume 0.04 L, 400 cpsi and 4 mil wall thickness, core of diameter: 1 inch x length: 3 inches), was coated with the obtained slurry over 100% of the substrate axial length. The coated substrate was dried in air at 110° C. for 1 h and subsequently calcined in air at 590° C. for 2 h, forming a bottom coating. The concentration of palladium in the bottom coating was 70 g/ft³, the concentration of the FER in bottom coating loading was 2.2 g/in³ and of ZrO₂ was 0.44 g/in³. The loading of the bottom coating was 2.64 g/in³.

### Top Coating (DOC Coating):

The top coating of Example 14 was prepared as the top coating of Example 12 and covers the aforementioned bottom coating over 100% of the substrate axial length. The total loading of the top coating was 1.9 g/in³.

TABLE 5

| | Bottom coating | Top coating |
|---|---|---|
| Sample | (substrate axial length) | (substrate axial length) |
| Comp. | 70 g/ft³ Pd-FER + | Inlet (50%): 20 g/ft³ |
| Example 2 | 5 wt.-% ZrO₂ (100%) | Pt/Pd-Alumina + Fe-Beta |
| | | Outlet (50%): 80 g/ft³ |
| | | Pt-Alumina |
| Example 12 | 70 g/ft³ Pd-FER + | 50 g/ft³ Pt Alumina + |
| | 5 wt.-% ZrO₂ + | Fe-Beta (100%) |
| | 0.7 wt.-% NaO + | |
| | 1 wt.-% MnO₂ (100%) | |
| Example 13 | 70 g/ft³ Pd-FER + | 50 g/ft³ Pt Alumina + |
| | 5 wt.-% ZrO₂ + | Fe-Beta (100%) |
| | 3 wt.-% SrO + | |
| | 1 wt.-% MnO₂ (100%) | |
| Example 14 | 70 g/ft³ Pd-FER + | 50 g/ft³ Pt Alumina + |
| | 20 wt.-% ZrO₂ + | Fe-Beta (100%) |
| | 4.3 wt.-% BaO + | |
| | 1 wt.-% MnO₂ (100%) | |

### Example 15: Evaluation of NOx Adsorber Diesel Oxidation Catalyst of Comparative Example 2 and Examples 8A and 12-14 on a Lab Reactor

Comparative Example 2 and Examples 8A and 12-14 were tested for NOx adsorption and desorption performance after hydrothermal aging at 800° C. for 16 hours in 10% steam (water)/air. Prior to desorption, the cores were exposed to a mixture of 200 ppm nitric oxide (NO), 500 ppm carbon monoxide (CO), 500 ppm propylene (C₃H₆, C₁ basis), 7% oxygen (O₂), 5% carbon dioxide (CO₂), 5% water (H₂O) and balance nitrogen (N₂) for 15 minutes at 100° C. During this period, NO was adsorbed to the Pd/FER. After the adsorption phase, the NO, CO and propylene were turned off and the temperature of the sample was raised to 500° C. at 20° C./min. During this period, NO that was adsorbed to the Pd/zeolite was desorbed (desorption phase). The temperature of NOx adsorption and the amount of desorbed NOx was evaluated. NO desorption curves for Comparative Example 2 and Examples 8A and 12-14 as a function of temperature are shown in FIG. 3. The amount of desorbed NOx is shown in Table 6. The amount of desorbed NOx relates to the previously adsorbed NOx at 100° C.

TABLE 6
Amount of desorbed NOx for Comparative Example 2
and Examples 8A and 12-14

| Sample | Desorbed amount of NOx/g/l |
|---|---|
| Comp. Example 2 | 0.56 |
| Example 12 | 0.56 |
| Example 13 | 0.54 |
| Example 14 | 0.51 |

As may be taken from FIG. 3, namely the NOx desorption curves, it can be concluded that the additive Mn, Ba+Mn, Na+Mn and Sr+Mn permit the desired increase of the NOx desorption temperature also with high Pd loading. The optimum NOx desorption windows are obtained with the catalysts according to the present invention.

### Comparative Example 3: Preparation of High Pd Containing a NOx Adsorber Diesel Oxidation Catalyst—CHA with Mn and Ba Additives

### Bottom Coating (NA Coating):

The bottom coating of Comparative Example 3 was prepared as the bottom coating of Example 14 except that an ammonium CHA zeolitic material (a zeolitic material having framework structure type CHA, a SiO₂:Al₂O₃ molar ratio of 14:1 and a crystallinity vs. standard (XRD)=81%) is used to replace the ammonium ferrierite zeolitic material from Example 14. The concentration of palladium in the bottom coating was 70 g/ft³, the concentration of the CHA in the bottom coating loading was 2.2 g/in³ and of ZrO₂ was 0.44 g/in³. The loading of the bottom coating was 2.64 g/in³.

### Top Coating (DOC Coating):

The top coating of Comparative Example 3 was prepared as the top coating of Example 14 and covers the aforementioned bottom coating over 100% of the substrate axial length. The total loading of the top coating was 1.9 g/in³.

### Comparative Example 4: Preparation of High Pd Containing a NOx Adsorber Diesel Oxidation Catalyst—BEA with Mn and Ba Additives

### Bottom Coating (NA Coating):

The bottom coating of Comparative Example 4 was prepared as the bottom coating of Example 14 except that an ammonium BEA zeolitic material (a zeolitic material having framework structure type BEA, a SiO₂:Al₂O₃ molar ratio of 14:1 and a crystallinity vs. standard (XRD) >80%) is used to replace the ammonium ferrierite zeolitic material from Example 14. The concentration of palladium in the bottom coating was 70 g/ft³, the concentration of the BEA in the bottom coating loading was 2.2 g/in³ and of ZrO₂ was 0.44 g/in³. The loading of the bottom coating was 2.64 g/in³.

### Top Coating (DOC Coating):

The top coating of Comparative Example 3 was prepared as the top coating of Example 14 and covers the aforementioned bottom coating over 100% of the substrate axial length. The total loading of the top coating was 1.9 g/in³.

TABLE 7

| | Bottom coating | Top coating |
|---|---|---|
| Sample | (substrate axial length) | (substrate axial length) |
| Comparative | 70 g/ft³ Pd-CHA + | 50 g/ft³ Pt Alumina + |
| Example 3 | 20 wt.-% ZrO₂ + | Fe-Beta (100%) |
| | 4.3 wt.-% BaO + | |
| | 1 wt.-% MnO₂ (100%) | |
| Comparative | 70 g/ft³ Pd-BEA + | 50 g/ft³ Pt Alumina + |
| Example 4 | 20 wt.-% ZrO₂ + | Fe-Beta (100%) |
| | 4.3 wt.-% BaO + | |
| | 1 wt.-% MnO₂ (100%) | |
| Example 14 | 70 g/ft³ Pd-FER + | 50 g/ft³ Pt Alumina + |
| | 20 wt.-% ZrO₂ + | Fe-Beta (100%) |
| | 4.3 wt.-% BaO + | |
| | 1 wt.-% MnO₂ (100%) | |

### Example 16: Evaluation of NOx Adsorber Diesel Oxidation Catalyst of Comparative Examples 3 and 4 and Example 14

Comparative Examples 3 and 4 and Example 14 were tested for NOx adsorption and desorption performance after hydrothermal aging at 800° C. for 16 hours in 10% steam (water)/air. Prior to desorption, the cores were exposed to a mixture of 200 ppm nitric oxide (NO), 500 ppm carbon monoxide (CO), 500 ppm propylene (C₃H₆, C₁ basis), 7% oxygen (O₂), 5% carbon dioxide (CO₂), 5% water (H₂O) and balance nitrogen (N₂) for 15 minutes at 100° C. During this period, NO was adsorbed to the Pd/zeolite. After the adsorption phase, the NO, CO and propylene were turned off and the temperature of the sample was raised to 500° C. at 60 K/min. During this period, NO that was adsorbed to the Pd/zeolite was desorbed (desorption phase). The temperature of NOx adsorption and the amount of desorbed NOx was evaluated. NO desorption curves for Comparative Examples 3 and 4 and Example 14 as a function of temperature are shown in FIG. 4. The amount of desorbed NOx is shown in Table 8. The amount of desorbed NOx relates to the previously adsorbed NOx at 100° C.

TABLE 8
Amount of desorbed NOx for Comparative
Examples 3 and 4 and Example 14

| Sample | Desorbed amount of NOx/g/l |
|---|---|
| Comp. Example 3 | 0.24 |
| Comp. Example 4 | 0.12 |
| Example 14 | 0.51 |

As may be taken from FIG. 4, namely the NOx desorption curves, it can be concluded that the catalyst according to the present invention permits the desired increase of the NOx desorption temperature also with high Pd loading compared to the catalysts representative of the prior art, namely the catalysts of Comparative Examples 3 and 4. The optimum NOx desorption windows are clearly obtained with the catalyst according to the present invention.

### Example 17: Preparation of High Pd Containing a NOx Adsorber Diesel Oxidation Catalyst—FER with Mn and Ba Additives

### Bottom Coating (NA Coating):

An ammonium ferrierite zeolitic material (a zeolitic material having framework structure type FER, a SiO₂:Al₂O₃ molar ratio of 21:1 and a crystallinity vs. standard (XRD) >80%) was wet impregnated with an aqueous palladium nitrate solution, barium hydroxide and manganese nitrate to attain a Pd loading of 1.14 weight-% based on the weight of the final material (zeolitic material+palladium), 4.3 weight-% BaO and 1 weight-% MnO₂ loading based on the FER amount. To the resulting slurry a zirconium acetate mixture was added. The amount of zirconium acetate was calculated such that the amount of zirconia in the bottom coating, calculated as ZrO₂, was 5 weight-% based on the weight of the zeolitic material. A porous uncoated round flow-through honeycomb substrate, cordierite (total volume 0.04 L, 400 cpsi and 4 mil wall thickness, core of diameter: 1 inch x length: 3 inches), was coated with the obtained slurry over 100% of the substrate axial length. The coated substrate was dried in air at 110° C. for 1 h and subsequently calcined in air at 590° C. for 2 h, forming a bottom coating. The concentration of palladium in the bottom coating was 50 g/ft³, the concentration of the FER in bottom coating loading was 2.5 g/in³ and of ZrO₂ was 0.125 g/in³. The loading of the bottom coating was 2.8 g/in³.

### Top Coating (DOC Coating):

The top coating of Example 17 was prepared as the top coating of Example 12 and covers the aforementioned bottom coating over 100% of the substrate axial length. The total loading of the top coating was 1.9 g/in³.

### Example 18: Preparation of High Pd Containing a NOx Adsorber Diesel Oxidation Catalyst—FER with Mn, Ba and Sr Additives

### Bottom Coating (NA Coating):

An ammonium ferrierite zeolitic material (a zeolitic material having framework structure type FER, a SiO₂:Al₂O₃ molar ratio of 21:1 and a crystallinity vs. standard (XRD) >80%) was wet impregnated with an aqueous palladium nitrate solution, barium hydroxide, strontium acetate and manganese nitrate to attain a Pd loading of 1.14 weight-% based on the weight of the final material (zeolitic material+palladium), 2 weight-% BaO, 0.5% weight-% SrO and 1 weight-% MnO₂ loading based on the FER amount. To the resulting slurry a zirconium acetate mixture was added. The amount of zirconium acetate was calculated such that the amount of zirconia in the bottom coating, calculated as ZrO₂, was 5 weight-% based on the weight of the zeolitic material. A porous uncoated round flow-through honeycomb substrate, cordierite (total volume 0.04 L, 400 cpsi and 4 mil wall thickness, core of diameter: 1 inch x length: 3 inches), was coated with the obtained slurry over 100% of the substrate axial length. The coated substrate was dried in air at 110° C. for 1 h and subsequently calcined in air at 590° C. for 2 h, forming a bottom coating. The concentration of palladium in the bottom coating was 50 g/ft³, the concentration of the FER in bottom coating loading was 2.5 g/in³ and of ZrO₂ was 0.125 g/in³. The loading of the bottom coating was 2.75 g/in³.

### Top Coating (DOC Coating):

The top coating of Example 17 was prepared as the top coating of Example 12 and covers the aforementioned bottom coating over 100% of the substrate axial length. The total loading of the top coating was 1.9 g/in³.

TABLE 9

| | Bottom coating | Top coating |
|---|---|---|
| Sample | (substrate axial length) | (substrate axial length) |
| Example 17 | 50 g/ft³ Pd-FER + | 50 g/ft³ Pt Alumina + |
| | 5 wt.-% ZrO₂ + | Fe-Beta (100%) |
| | 4.3 wt.-% BaO + | |
| | 1 wt.-% MnO₂ (100%) | |
| Example 18 | 50 g/ft³ Pd-FER + | 50 g/ft³ Pt Alumina + |
| | 5 wt.-% ZrO₂ + | Fe-Beta (100%) |
| | 2 wt.-% BaO + | |
| | 0.5% SrO + 1 wt.-% | |
| | MnO₂ (100%) | |

### Example 19: Evaluation of NOx Adsorber Diesel Oxidation Catalyst of Examples 17 and 18 on a Lab Reactor

The catalysts of Examples 17 and 18 were tested as defined in Example 16.

TABLE 10
Amount of desorbed NOx for Examples 17 and 18

| Sample | Desorbed amount of NOx/g/l |
|---|---|
| Example 17 | 0.34 |
| Example 18 | 0.41 |

As may be taken from FIG. 5, namely the NOx desorption curves, it can be concluded that the additives Mn+Ba+Sr and Mn+Ba permit the desired increase of the NOx desorption temperature also with medium Pd loading.

### BRIEF DESCRIPTION OF THE FIGURES

FIG. 1 shows the NOx desorption curves obtained with the catalysts of Comparative Example 1 and of Examples 1 to 6.

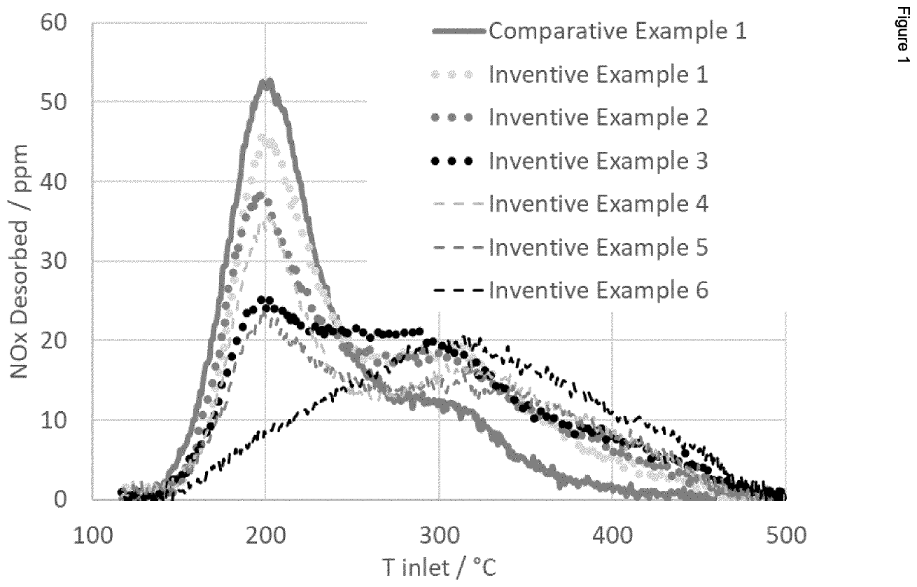

FIG. 2 shows the NOx desorption curves obtained with the catalysts of Comparative Example 2 and of Examples 8A and 8 to 10.

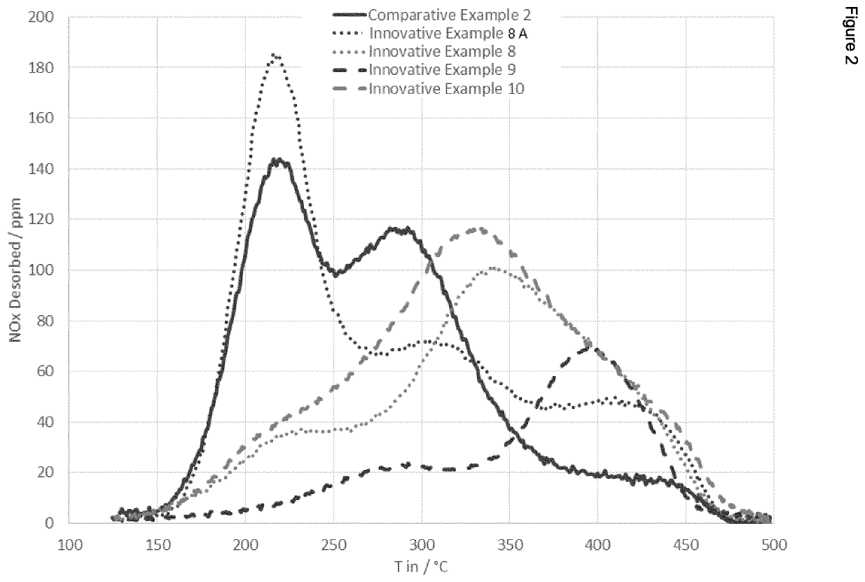

FIG. 3 shows the NOx desorption curves obtained with the catalysts of Comparative Example 2 and of Examples 12 to 14.

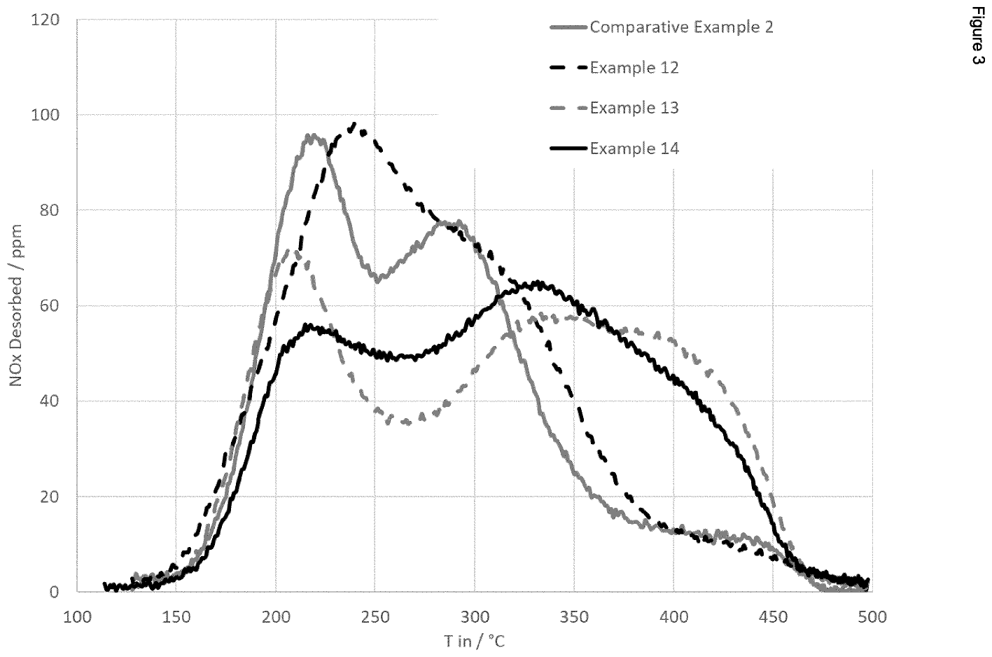

FIG. 4 shows the NOx desorption curves obtained with the catalysts of Comparative Examples 3 and 4 and of Example 14.

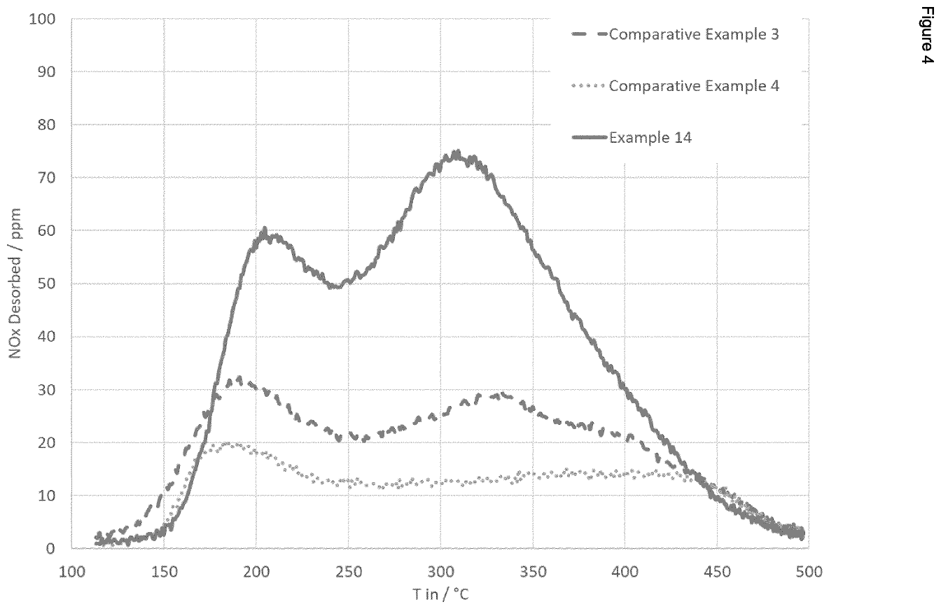

FIG. 5 shows the NOx desorption curves obtained with the catalysts of Examples 17 and 18.

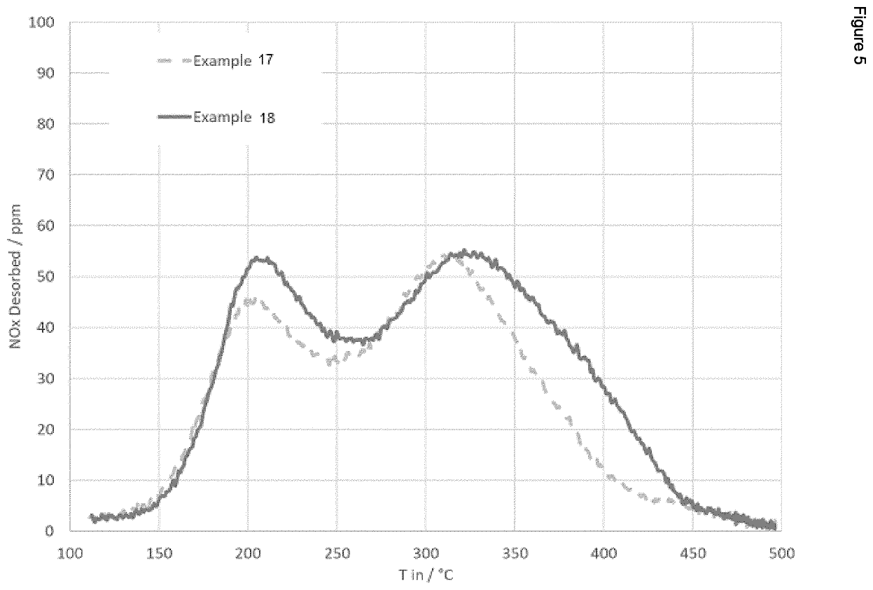

### CITED LITERATURE

WO 2020/0236879

1. A NOx adsorber diesel oxidation catalyst (NA-DOC) for the treatment of an exhaust gas, the catalyst comprising:
(i) a substrate comprising an inlet end, an outlet end, a substrate axial length extending from the inlet end to the outlet end and a plurality of passages defined by internal walls of the substrate extending therethrough;
(ii) a NOx adsorber (NA) coating disposed on the surface of the internal walls of the substrate (i), said coating comprising a platinum group metal, a zeolitic material and one or more of an alkaline earth metal and manganese;
(iii) a diesel oxidation catalyst (DOC) coating, said coating comprising a platinum group metal supported on a non-zeolitic oxidic material.

2. The catalyst of claim 1, wherein the platinum group metal comprised in the NA coating (ii) is selected from the group consisting of palladium, platinum, rhodium, iridium, osmium, ru-thenium and a mixture of two or more thereof, preferably selected from the group consist-ing of palladium, platinum and rhodium, more preferably selected from the group consist-ing of palladium and platinum.

3. The catalyst of claim 1, wherein the zeolitic material comprised in the NA coating (ii) is a 10-membered ring pore zeolitic material, wherein the 10-membered ring pore zeolitic material preferably has framework type selected from the group consisting of FER, TON, MTT, SZR, MFI, MWW, AEL, HEU, AFO, a mixture of two or more thereof and a mixed type of two or more thereof, more preferably selected from the group consisting of FER, TON, MFI, MWW, AEL, HEU, AFO, a mixture of two or more thereof and a mixed type of two or more thereof, more preferably selected from the group consisting of FER and TON, wherein more preferably the 10-membered ring pore zeolitic material comprised in the NA coating (ii) has a framework type FER.

4. The catalyst of claim 2, wherein platinum group metal comprised in the NA coating (ii) is palladium and wherein the zeolitic material comprised in the NA coating (ii) is a 10-membered ring pore zeolitic material having a framework type FER or TON, preferably FER.

5. The catalyst of claim 1, wherein the NA coating (ii) comprises an alkaline earth metal, wherein the alkaline earth metal is preferably selected from the group consisting of barium, strontium, calcium, magnesium and a mixture of two or more thereof, more preferably selected from the group consisting of barium, strontium, magnesium and a mix-ture of two or more thereof, more preferably is barium, strontium and a mixture of two or more thereof, more preferably is barium or strontium or barium and strontium;
wherein the NA coating (ii) preferably comprises the alkaline earth metal in a total amount, calculated as the oxide, in the range of from 0.5 to 15 weight-%, more preferably in the range of from 1 to 10 weight-%, more preferably in the range of from 1.5 to 8 weight-%, based on the weight of the zeolitic material comprised in the NA coating (ii).

6. The catalyst of claim 1, wherein the NA coating (ii) comprises manga-nese, wherein the NA coating (ii) preferably comprises manganese in an amount calculat-ed as MnO₂, in the range of from 0.25 to 5 weight-%, more preferably in the range of from 0.5 to 3 weight-%, more preferably in the range of from 0.75 to 1.5 weight-% based on the weight of the zeolitic material comprised in the NA coating (ii).

7. The catalyst of claim 5, wherein the NA coating (ii) comprises barium and manga-nese; or strontium and manganese; or barium, strontium and manganese.

8. The catalyst of claim 6, wherein the NA coating (ii) further comprises an alkali metal, wherein the alkali metal is preferably selected from the group consisting of sodium, potas-sium and lithium, wherein the alkali metal is preferably sodium.

9. The catalyst of claim 1, wherein the platinum group metal comprised in the DOC coating (iii) is selected from the group consisting of palladium, platinum, rhodi-um, iridium, osmium and ruthenium and a mixture of two or more thereof, preferably se-lected from the group consisting of palladium, platinum and rhodium, more preferably se-lected from the group consisting of palladium and platinum, more preferably is platinum.

10. The catalyst of claim 1, wherein the NA coating disposed on the surface of the internal walls of the substrate (i) extends over x % of the substrate axial length, preferably from the outlet end towards the inlet end, with x being in the range of from 40 to 100 and wherein the DOC coating extends over y % of the substrate axial length, prefera-bly from the inlet end towards the outlet end, with y being in the range of from 20 to 100.

11. The catalyst of claim 1, wherein the DOC coating (iii) has a single coat.

12. The catalyst of claim 1, wherein the DOC coating (iii) comprises, prefer-ably consists of,
(iii.1) an inlet coat comprising the platinum group metal, preferably platinum, the non-zeolitic oxidic material and a zeolitic material; and
(iii.2) an outlet coat comprising the platinum group metal, preferably platinum, and the non-zeolitic oxidic material;
wherein the inlet coat (iii.1) extends over y1% of the substrate axial length from the inlet end towards the outlet end of the substrate according to (i), wherein y1 is in the range of from 20 to 80, preferably in the range of from 30 to 60, more preferably in the range of from 45 to 55, and wherein the outlet coat (iii.2) extends over y2% of the substrate axial length from the out-let end towards the inlet end of the substrate according to (i), wherein y2 is in the range of from 20 to 80, preferably in the range of from 30 to 60, more preferably in the range of from 45 to 55.

13. The catalyst of claim 1, wherein the DOC coating is disposed on the NA coating; preferably, wherein the DOC coating extends over y % of the substrate axial length, with y being in the range of from 98 to 100 and the NA coating extends over x % of the substrate axial length, more preferably from the outlet end towards the inlet end of the substrate, with x being in the range of from 98 to 100.

14. Process for preparing a NOx adsorber diesel oxidation catalyst (NA-DOC), preferably the NOx adsorber diesel oxidation catalyst (NA-DOC) according to claim 1, comprising
(a) preparing a first mixture comprising water, a source of a platinum group metal, a ze-olitic material and a source of one or more of an alkaline earth metal and manganese;
(b) disposing the first mixture obtained according to (a) on the surface of the internal walls of a substrate comprising an inlet end, an outlet end, a substrate axial length extending from the inlet end to the outlet end and a plurality of passages defined by internal walls of the substrate extending therethrough; calcining, obtaining a sub-strate having a NA coating thereon;
(c) preparing a second mixture comprising water, a source of a platinum group metal and a non-zeolitic oxidic material;
(d) disposing the second mixture obtained according to (c) on the substrate having a NA coating thereon;
(e) calcining the substrate obtained according to (d), obtaining a substrate having a NA coating and a DOC coating thereon.

15. A NOx adsorber diesel oxidation catalyst (NA-DOC) obtained or obtainable by a process according to claim 14.

16. Use of a NOx adsorber diesel oxidation catalyst (NA-DOC) according to claim 1 for the NOx adsorption/desorption and the conversion of HC and CO.

17. An exhaust treatment system for the treatment of an exhaust gas, the system comprising a NOx adsorber diesel oxidation (NA-DOC) catalyst according to claim 1;
the system further comprises one or more of a selective catalytic reduction catalyst (SCR), a selective catalytic reduction catalyst on a filter (SCRoF) and an ammonia oxidation (AMOX) catalyst,
wherein the NA-DOC catalyst is preferably located upstream of the one or more of a selective catalytic reduction catalyst (SCR), a selective catalytic reduction catalyst on a filter (SCRoF) and an ammonia oxidation (AMOX) catalyst.
